(19) United States
(12) Patent Application Publication
(10) Pub. No.: US 2010/0195237 A1
(43) Pub. Date: Aug. 5, 2010

(54) MAGNETIC RECORDING MEDIUM, RECORDING/REPRODUCING APPARATUS, AND STAMPER

(75) Inventors: Takahiro Suwa, Tokyo (JP); Narutoshi Fukuzawa, Tokyo (JP)

Correspondence Address: GREENBLUM & BERNSTEIN, P.L.C., 1950 ROLAND CLARKE PLACE, RESTON, VA, 20191, US

(73) Assignee: TDK CORPORATION, Tokyo (JP)

(21) Appl. No.: 12/698,228

(22) Filed: Feb. 2, 2010

(30) Foreign Application Priority Data
Feb. 5, 2009 (JP) 2009-25166

(51) Int. Cl. G11B 5/09; G11B 17/00

(52) U.S. Cl. 360/48; 360/69; G9B/5.033; G9B/17

(57) ABSTRACT

A magnetic recording medium has data track patterns formed by concave/convex patterns in data recording regions on at least one surface of a substrate and servo patterns formed by concave/convex patterns in servo pattern regions between the data recording regions. The concave/convex patterns include convexes, at least protruding end portions of which are formed of magnetic material, and concaves. A burst pattern region of each servo pattern region includes N (where N is at least two) burst regions, in which burst patterns, where plural burst signal unitary parts are aligned along a direction of rotation, are formed as the servo patterns. The burst signal unitary parts formed in M (where M is no greater than (N−1)) out of the N burst regions are concaves, and the burst signal unitary parts formed in L (where L is equal to (N−M)) out of the N burst regions are convexes.

### BACKGROUND OF THE INVENTION

1. Field of the Invention

The present invention relates to a magnetic recording medium on which data track patterns and servo patterns are formed by concave/convex patterns composed of concaves and convexes, where at least protruding end portions of the convexes are formed of a magnetic material, to a recording/reproducing apparatus equipped with such magnetic recording medium, and to a stamper used to manufacture the magnetic recording medium itself or further a stamper that will be used to manufacture the magnetic recording medium.

2. Description of the Related Art

As one example of this type of magnetic recording medium, Japanese Laid-Open Patent Publication No. 2006-31856 discloses a DTR-type patterned disk medium (hereinafter, sometimes referred to simply as a “disk medium”) on which data track patterns and servo patterns are constructed by concave/convex patterns. In a data region (data recording region) on this disk medium, plural magnetic tracks (discrete tracks) formed as convexes and non-magnetic guards formed as concaves between the respective magnetic tracks are formed as a data track pattern. A servo region (servo pattern region) on this disk medium is provided with a preamble portion in which are formed plural non-magnetic portions (concaves) and magnetic portions (convexes) that are separated in the circumferential direction (direction of rotation) of the disk medium but are continuous and long in the radial direction, an address portion in which are formed magnetic parts (convexes) corresponding to “ones” in an address data code and non-magnetic parts (concaves) corresponding to “zeros” in the code, and a burst portion in which four types of bursts, called burst A to burst D, are formed by concave/convex patterns.

Here, on this disk medium, the length along the direction of rotation of the magnetic parts (convexes) in the preamble portion is set so as to be around 50% of the repeated period in which a magnetic part and a non-magnetic part are present. Accordingly on this disk medium, the ratio of the total area of the concaves in a preamble portion to the total area of the convexes in the preamble portion is “1:1” (in other words, a value produced by dividing the total area of the convexes in the preamble portion by the total area of the concaves in the preamble portion is “1/1=1”). In this specification, a value produced by dividing the total area of convexes by the total area of concaves is sometimes referred to as the “value of the ratio between concaves and convexes”. Also, on this type of disk medium, the total area of the concaves and the total area of the convexes in an address portion (that is the respective numbers of “zeros” and “ones” in an address data code) are substantially equal. Accordingly, on this disk medium, the ratio of the total area of the concaves in an address portion to the total area of the convexes in the address portion is substantially “1:1” (the value of the ratio between concaves and convexes in an address portion is “1/1=1”). In addition, on this disk medium, in all of the four bursts (bursts A to D) in the burst portion, the burst signal unitary parts (unitary signal regions that are quadrangular when viewed from above) are composed of non-magnetic parts (concaves) and the periphery thereof is composed of magnetic parts (convexes). Accordingly, on this disk medium, the ratio of the total area of the concaves in a burst portion to the total area of the convexes in the burst portion is “1:3” (the value of the ratio between concaves and convexes of the burst portion is “3/1=3”).

On the other hand, on this type of disk medium, the data track patterns are formed so that the length (width) along the radial direction of the magnetic tracks (convexes) in the data regions and length (width) along the radial direction of the non-magnetic guards (concaves) are equal for example (see for example, the discrete-track medium (magnetic recording medium) disclosed by the present applicant in Japanese Laid-Open Patent Publication No. 2005-38476). Here, on a disk medium formed so that the length (width) along the radial direction of the magnetic tracks (convexes) and the length (width) along the radial direction of the non-magnetic guards (concaves) are equal, the ratio of the total area of the concaves in the data regions (data recording regions) to the total area of the convexes in the data regions is “1:1” (the value of the ratio between concaves and convexes of the data regions is “1/1=1”).

### SUMMARY OF THE INVENTION

However, by investigating the conventional disk medium, the present inventors found the following problems. That is, on the conventional disk medium, in the preamble portions and address portions in the servo regions (servo pattern regions) and in the data regions (data recording regions), the ratio of the total area of the concaves to the total area of the convexes is “1:1” (the value of the ratio between concaves and convexes is “1/1=1”). However, in the burst portions in the servo regions (servo pattern regions), the ratio of the total area of the concaves to the total area of the convexes is “1:3” (the value of the ratio between concaves and convexes is “3/1=3”). Here, with this type of disk medium, recording and reproducing of data and reads of servo data are carried out via a magnetic head that flies above the disk surface as the disk medium rotates.

It is also known that on a magnetic disk where data track patterns and servo patterns are constructed of concave/convex patterns as on the conventional disk medium, the larger the total area of the concaves located below the magnetic head (head slider) (i.e., the smaller the total area of the convexes, or the smaller the value of the ratio between concaves and convexes), the lower the flying height of the magnetic head above the magnetic disk, and the larger the total area of the convexes located below the magnetic head (head slider) (i.e., the smaller the total area of the concaves, or the greater the value of the ratio between concaves and convexes), the higher the flying height of the magnetic head above the magnetic disk. Accordingly, with the conventional magnetic disk, during recording and reproducing, the flying height of the magnetic head will be greater when a burst portion is located below the magnetic head (as an example, when a data region, a preamble portion, an address portion, and a burst portion are all located below the magnetic head) than when a burst portion is not located below the magnetic head during recording and reproducing (for example, when only a data region, a preamble portion, and an address portion are located below the magnetic head). For this reason, with the conventional disk medium, there is large fluctuation in the flying height of the magnetic head during one revolution of the disk medium, and due to this, there is the problem of increased probability that a head crash will occur.

More specifically, as one example, when concaves with a depth of 20 nm are formed in the data regions, the preamble portions, and the address portions where the respective values of the ratios between concaves and convexes are all “1/1=1”), the average depth from the protruding end surfaces of the convexes in the respective regions (the average height in the respective regions measured relative to the protruding end surfaces of the convexes) will be 10 nm. On the other hand, when concaves with a depth of 20 nm are formed in the burst portions where the value of the ratio between concaves and convexes is “3/1=3”, the average depth from the protruding end surfaces of the convexes in each burst portion will be 5 nm. Accordingly, on the conventional disk medium, the difference between the average depth in the data regions, the preamble portions, and the address portions and the average depth in the burst portions is 5 nm, and due to this, a difference is produced in the flying height of the head between a state where a burst portion is not located below the magnetic head (slider) and a state where a burst portion is located below the magnetic head. As a result, there is large fluctuation in the flying height of the magnetic head per revolution of the disk medium.

A disk medium where burst signal unitary parts inside the burst portions (burst pattern regions) are formed of convexes is also known. On this disk medium, the ratio of the total area of the concaves to the total area of the convexes in the burst portion is “3:1” (the value of the ratio between concaves and convexes is “1/3”). On this disk medium, when concaves with a depth of 20 nm are formed in the burst regions, the average depth from the protruding end surfaces of the convexes in each burst portion will be 15 nm. Accordingly, on a disk medium where the burst signal unitary parts are formed of convexes, the difference between the average depth in the data regions, the preamble portions, and the address portions and the average depth in the burst portions is 5 nm, and due to this, there is a large difference in the flying height of the head between the state where a burst portion is not located below the magnetic head (slider) and the state where a burst portion is located below the magnetic head. As a result, on this disk medium also, there is large fluctuation in the flying height of the magnetic head per revolution.

The present invention was conceived in view of the problems described above and it is a principal object of the present invention to provide a magnetic recording medium and a recording/reproducing apparatus that are capable of sufficiently reducing fluctuation in the flying height of the magnetic head, and a stamper manufactured corresponding to the magnetic recording medium.

On a magnetic recording medium according to the present invention, data track patterns are formed by first concave/convex patterns in data recording regions on at least one surface of a substrate and servo patterns are formed by second concave/convex patterns in servo pattern regions located between the data recording regions on the at least one surface, and the first and second concave/convex patterns include concaves and convexes where at least protruding end portions of the convexes are formed of a magnetic material, wherein a burst pattern region of each servo pattern region includes N (where N is a natural number of at least two) burst regions, in which burst patterns, where plural burst signal unitary parts are aligned along a direction of rotation of the magnetic recording medium, are formed as the servo patterns, the burst signal unitary parts formed in M (where M is a natural number no greater than (N−1)) (M≦(N−1)) out of the N burst regions are constructed of the concaves, and the burst signal unitary parts formed in L (where L is a natural number equal to (N−M)) out of the N burst regions are constructed of the convexes.

A recording/reproducing apparatus according to the present invention includes the magnetic recording medium described above.

Note that the expression “concave/convex pattern” used in this specification refers to a “convex and concave pattern in which concaves and convexes are disposed (provided)”. Also, the expression “burst region” in this specification refers to a “region in which one type of burst pattern is formed”. In this case, the expression “one type of burst pattern” refers to any of an “A burst”, a “B burst”, a “C burst”, and a “D burst”, for example. Note that a burst pattern in which the burst signal unitary parts are formed of concaves and a burst pattern in which the burst signal unitary parts are formed of convexes are regarded as different types of burst pattern.

According to the magnetic recording medium described above and the recording/reproducing apparatus equipped with such magnetic recording medium, since it is possible to sufficiently reduce the difference between the head flying height in a state where a burst pattern region is not located below a magnetic head (slider) and the head flying height in a state where a burst pattern region is located below the magnetic head (slider), it is possible to sufficiently reduce the fluctuation in the flying height of the magnetic head per revolution of the magnetic recording medium. By doing so, according to the above magnetic recording medium and the recording/reproducing apparatus equipped with such magnetic recording medium, it is possible to prevent the occurrence of head crashes and to favorably avoid damage to the magnetic recording medium and the magnetic head.

Here, the values of M and L may be set so that a ratio of an area of the concaves in the second concave/convex patterns that construct the burst patterns to an area of the convexes in the second concave/convex patterns that construct the burst patterns is as close as possible to a ratio of an area of the concaves in the first concave/convex patterns that construct the data track patterns to an area of the convexes in the first concave/convex patterns that construct the data track patterns. Note that the expression “the area of the concaves” used in this specification refers to the area of the opening surfaces of the concaves (i.e., the areas of the openings at the same height as the protruding end surfaces of convexes adjacent to the concaves). Also, the expression “the area of the convexes” used in this specification refers to the area of the protruding end surfaces of the convexes. In addition, in this specification, the “ratio between the area of the concaves and the area of the convexes” is referred to as the “value of the ratio between concaves and convexes”. In this specification, a “value produced by dividing the area of the convexes by the area of the concaves (that is, the area of the convexes relative to the area of the concaves)” is regarded as the “value of the ratio between concaves and convexes”.

According to the above magnetic recording medium and the recording/reproducing apparatus equipped with such magnetic recording medium, since it is possible to significantly reduce the difference between the head flying height in a state where a burst pattern region is not located below the magnetic head (slider) and a state where a burst pattern region is located below the magnetic head (slider), it is possible to significantly reduce the fluctuation in the flying height of the magnetic head per revolution of the magnetic recording medium. By doing so, according to the above magnetic recording medium and the recording/reproducing apparatus equipped with such magnetic recording medium, it is possible to reliably prevent the occurrence of head crashes.

Also, the values of M and L may be set so that a ratio of an area of the concaves in the second concave/convex patterns that construct the servo patterns to an area of the convexes in the second concave/convex patterns that construct the servo patterns is as close as possible to a ratio of an area of the concaves in the first concave/convex patterns that construct the data track patterns to an area of the convexes in the first concave/convex patterns that construct the data track patterns.

According to the above magnetic recording medium and the recording/reproducing apparatus equipped with such magnetic recording medium, since it is possible to sufficiently reduce the difference between the head flying height in a state where a servo pattern region is not located below the magnetic head (slider) and a state where a servo pattern region is located below the magnetic head (slider), it is possible to significantly reduce the fluctuation in the flying height of the magnetic head per revolution of the magnetic recording medium. By doing so, according to the above magnetic recording medium and the recording/reproducing apparatus equipped with such magnetic recording medium, it is possible to reliably prevent the occurrence of head crashes.

It is also possible to set the values of M and L so that a ratio of an area of the concaves in the second concave/convex patterns that construct the burst patterns to an area of the convexes in the second concave/convex patterns that construct the burst patterns is as close as possible to a ratio of (i) a total of an area of the concaves in the second concave/convex patterns that construct parts of the servo patterns aside from the burst patterns and an area of the concaves in the first concave/convex patterns that construct the data track patterns to (ii) a total of an area of the convexes in the second concave/convex patterns that construct parts of the servo patterns aside from the burst patterns and an area of the convexes in the first concave/convex patterns that construct the data track patterns.

According to the above magnetic recording medium and the recording/reproducing apparatus equipped with such magnetic recording medium, since it is possible to significantly reduce the difference between the head flying height in a state where a burst pattern region is not located below the magnetic head (slider) and a state where a burst pattern region is located below the magnetic head (slider), it is possible to significantly reduce the fluctuation in the flying height of the magnetic head per revolution of the magnetic recording medium. By doing so, according to the above magnetic recording medium and the recording/reproducing apparatus equipped with such magnetic recording medium, it is possible to reliably prevent the occurrence of head crashes.

Also, the burst patterns may be formed in the burst pattern regions so that the burst regions in which the burst signal unitary parts are constructed of the concaves and the burst regions in which the burst signal unitary parts are constructed of the convexes alternate in the direction of rotation.

According to the above magnetic recording medium and the recording/reproducing apparatus equipped with such magnetic recording medium, since it is possible to sufficiently reduce the extent to which the concaves and the convexes are unbalanced inside the burst pattern regions, it is possible to significantly reduce the fluctuation in the flying height of the magnetic head per revolution of the magnetic recording medium. By doing so, according to the above magnetic recording medium and the recording/reproducing apparatus equipped with such magnetic recording medium, it is possible to reliably prevent the occurrence of head crashes.

On a stamper according to the present invention, a stamper-side concave/convex pattern is formed including stamper-side convexes formed corresponding to one of the concaves and the convexes of the concave/convex patterns of the magnetic recording medium described above and stamper-side concaves formed corresponding to another of the concaves and the convexes of the concave/convex patterns of the magnetic recording medium described above.

According to the above stamper, it is possible to manufacture the magnetic recording medium described above or another stamper used when manufacturing the magnetic recording medium described above. Also, according to the above stamper (a stamper for use during an imprinting process to manufacture the magnetic recording medium described above), it is possible to sufficiently reduce fluctuation in the ratios in respective regions, such as regions corresponding to the data recording regions and regions corresponding to the burst pattern regions, between the total area in the respective regions of the stamper-side convexes formed corresponding to one of the convexes and concaves in the concave/convex patterns on the magnetic recording medium and the total area in the respective regions of the stamper-side concaves formed corresponding to the other of the convexes and concaves in the concave/convex patterns on the magnetic recording medium (i.e., the values of the ratios between convexes and concaves of the respective regions in the stamper-side concave/convex pattern) or to sufficiently reduce fluctuation in the ratios in the respective regions between the total area in the respective regions of the stamper-side concaves and the total area in the respective regions of the stamper-side convexes (i.e., the values of the ratios between concaves and convexes of the respective regions in the stamper-side concave/convex pattern). Accordingly, when transferring the stamper-side concave/convex pattern onto a resin layer (mask forming layer) on a preform used to manufacture the magnetic recording medium during imprinting when manufacturing the magnetic recording medium, it is possible to press in the stamper-side convexes uniformly across the entire stamper. This means that it is possible to form the concave/convex pattern used for an etching process (i.e., a mask pattern) with high precision.

It should be noted that the disclosure of the present invention relates to a content of Japanese Patent Application 2009-025166 that was filed on 5 Feb. 2009 and the entire content of which is herein incorporated by reference.

### BRIEF DESCRIPTION OF THE DRAWINGS

These and other objects and features of the present invention will be explained in more detail below with reference to the attached drawings, wherein:

FIG. 1 is a diagram showing the construction of a hard disk drive;

FIG. 2 is a cross-sectional view of a magnetic disk;

FIG. 3 is a plan view of a magnetic disk;

FIG. 4 is another plan view of a magnetic disk;

FIG. 5 is a cross-sectional view of a preform and a stamper for manufacturing a magnetic disk;

FIG. 6 is a cross-sectional view of another stamper for manufacturing the above stamper;

FIG. 7 is a cross-sectional view of yet another stamper for manufacturing the other stamper;

FIG. 8 is a cross-sectional view of a perform in a state where a concave/convex pattern has been formed by transferring a concave/convex pattern of a stamper onto a B mask layer on the preform;

FIG. 9 is a cross-sectional view of the preform in a state where a concave/convex pattern has been formed on an A mask layer using the concave/convex pattern as a mask;

FIG. 10 is a diagram useful in explaining the positional relationship between a magnetic head and a first burst region to a fourth burst region on another magnetic disk;

FIG. 11 is a diagram useful in explaining an output signal outputted from the magnetic head in a state where the magnetic head is located at a radial position shown by a solid line in FIG. 10;

FIG. 12 is a diagram useful in explaining an output signal outputted from the magnetic head in a state where the magnetic head is located at a radial position shown by a dot-dash line in FIG. 10;

FIG. 13 is a diagram useful in explaining an output signal outputted from the magnetic head in a state where the magnetic head is located at a radial position shown by a dot-dot-dash line in FIG. 10;

FIG. 14 is a plan view of yet another magnetic disk;

FIG. 15 is a plan view of yet another magnetic disk;

FIG. 16 is a plan view of yet another magnetic disk;

FIG. 17 is a plan view of yet another magnetic disk;

FIG. 18 is a plan view of yet another magnetic disk;

FIG. 19 is a cross-sectional view of yet another magnetic disk;

FIG. 20 is a cross-sectional view of yet another magnetic disk; and

FIG. 21 is a cross-sectional view of yet another magnetic disk.

### DESCRIPTION OF THE PREFERRED EMBODIMENTS

Preferred embodiments of a magnetic recording medium, a recording/reproducing apparatus, and a stamper according to the present invention will now be described with reference to the attached drawings.

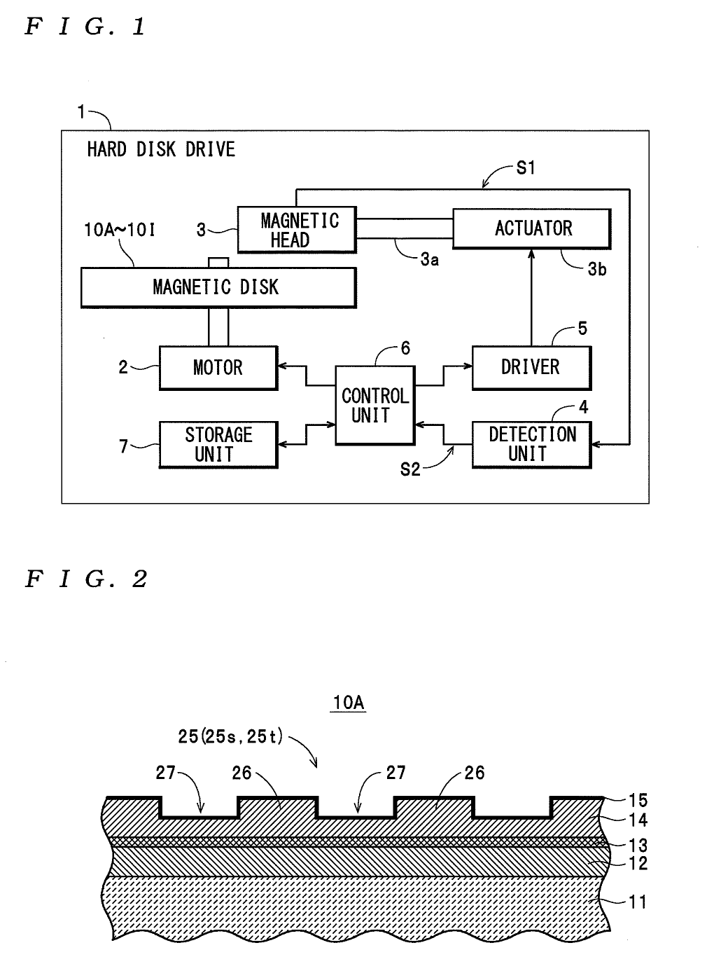

The hard disk drive 1 shown in FIG. 1 is one example of a recording/reproducing apparatus according to the present invention, includes a motor 2, a magnetic head 3, a detection unit 4, a driver 5, a control unit 6, a storage unit 7, and a magnetic disk 10A, and is capable of recording and reproducing various types of data.

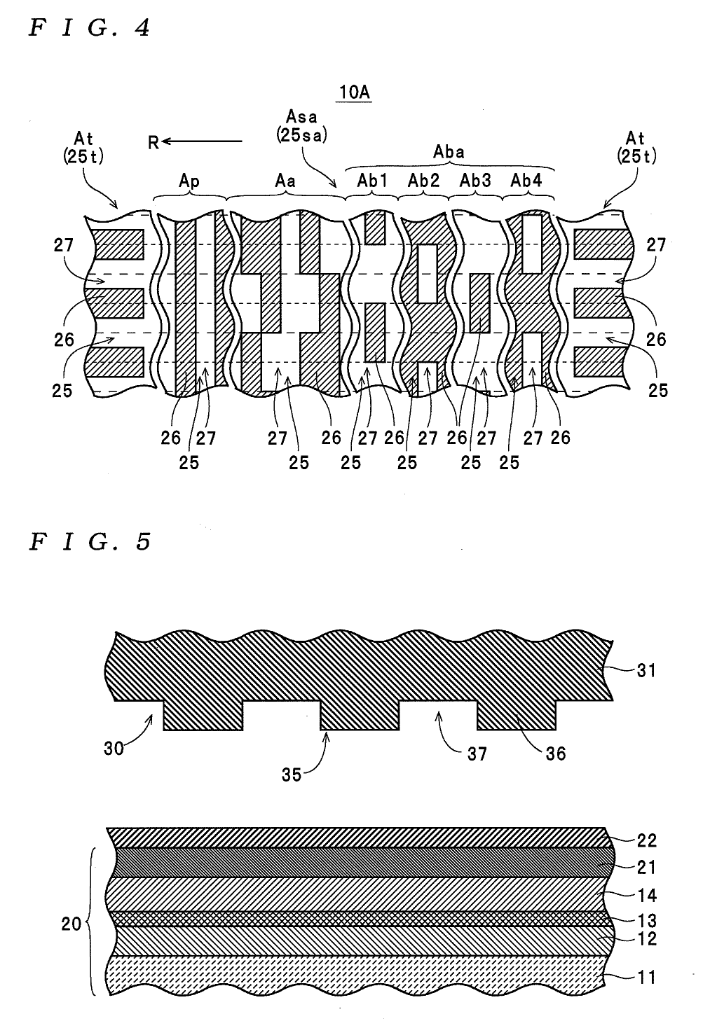

In accordance with control by the control unit 6, the motor 2 rotates the magnetic disk 10A at a constant velocity. The magnetic head 3 is attached to the actuator 3b via a swing arm 3a and is moved over the magnetic disk 10A by an actuator 3b during recording and reproducing of data on the magnetic disk 10A. The magnetic head 3 carries out reads of servo data from servo pattern regions Asa (see FIGS. 3, 4) of the magnetic disk 10A, magnetic writes of data in data recording regions At (see FIGS. 3, 4), and reads of data that has been magnetically written in the data recording regions At. Note that although the magnetic head 3 is actually constructed with a reproducing element and a recording element formed on a base surface (air bearing surface) of a slider for causing the magnetic head 3 to fly above the magnetic disk 10A, the slider and both elements are omitted from the explanation and the drawings. Also, by swinging the swing arm 3a according to a driving current supplied from the driver 5 under the control of the control unit 6, the actuator 3b moves the magnetic head 3 to an arbitrary recording/reproducing position (an arbitrary track) above the magnetic disk 10A.

Note that although in FIG. 1, a state where the magnetic head 3 is present on only one surface of the magnetic disk 10A (the upper surface in FIG. 1) is shown for ease of understanding the present invention, in reality, since the magnetic disk 10A is a two-sided recording medium, a magnetic head 3 is also present on the other surface (the lower surface in FIG. 1) of the magnetic disk 10A. Also, when plural magnetic disks 10A are mounted inside a single hard disk drive 1, a pair of magnetic heads 3 will be present for each magnetic disk 10A. The detection unit 4 obtains (detects) servo data from an output signal S1 outputted from the magnetic head 3 and outputs the servo data to the control unit 6 as a detection signal S2. Note that the relationship between the output signal S1 from the magnetic head 3 and the detection signal S2 outputted from the detection unit 4 corresponding to the output signal S1 will be described in detail later. The driver 5 controls the actuator 3b in accordance with the control signal outputted from the control unit 6 to keep the magnetic head 3 on-track to a desired track. The control unit 6 carries out overall control of the hard disk drive 1. Also, the control unit 6 controls the driver 5 based on the detection signal S2 (servo data) outputted from the detection unit 4 (i.e., the control unit 6 carries out a tracking servo control process). The storage unit 7 stores an operation program of the control unit 6 and the like.

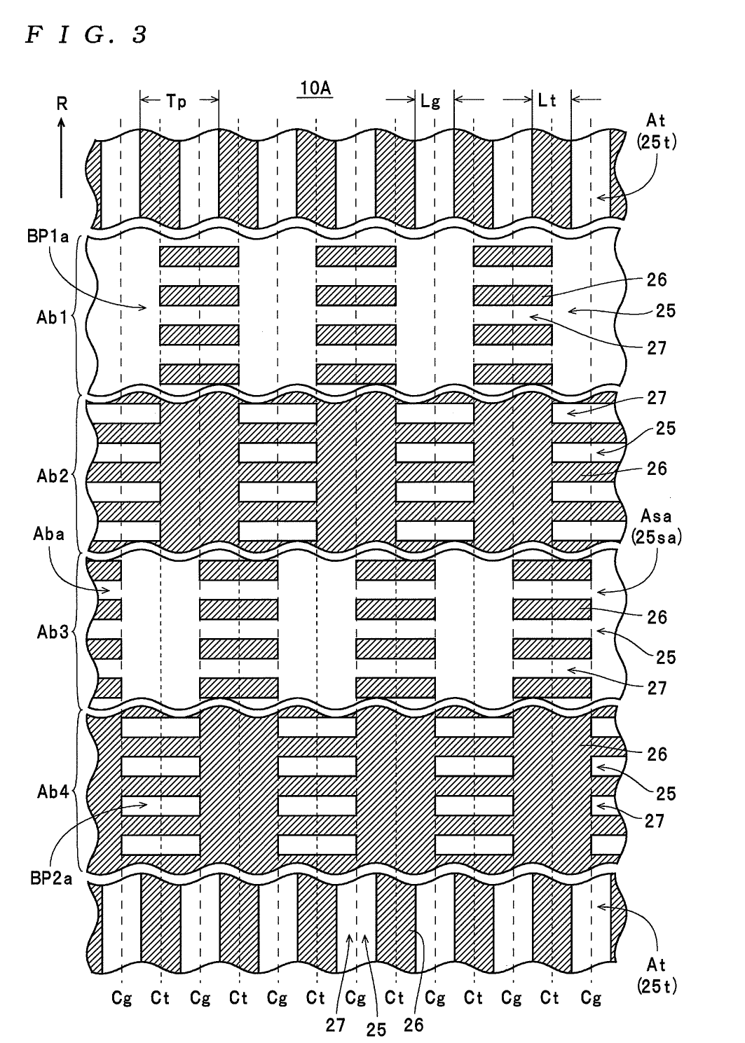

On the other hand, the magnetic disk 10A is one example of a magnetic recording medium according to the present invention, and is disposed inside a case of the hard disk drive 1 together with the motor 2 and the magnetic head 3 described earlier. The magnetic disk 10A is a discrete-track type magnetic recording medium (patterned medium) that is capable of recording data according to perpendicular recording and as shown in FIG. 2 has a soft magnetic layer 12, an intermediate layer 13, and a magnetic layer 14 formed in the mentioned order on a glass base plate 11. Here, the magnetic layer 14 constructs concave/convex patterns 25 in which convexes 26, which are entirely formed of magnetic material from protruding end portions thereof (the surface of the magnetic disk 10A-side of the convexes, the upper end portions in FIG. 2) to the base end portions (the lower end portions in FIG. 2), and concaves 27, which are located between the adjacent convexes 26, are formed. In addition, on the magnetic disk 10A, a protective layer 15 (DLC film) of diamond-like carbon (DLC) or the like is formed so as to cover the concave/convex patterns 25 formed in the magnetic layer 14. Also, a lubricant is applied onto the surface of the protective layer 15 to prevent damage to both the magnetic head 3 and the magnetic disk 10A.

As one example, the glass base plate 11 is a substrate for the present invention and formed in a disk shape by grinding the surface of a 1.89-inch glass plate. Note that the substrate used as the magnetic disk 10A is not limited to the glass substrate described above, and it is possible to use a substrate formed in a disk shape using a variety of non-magnetic materials, such as aluminum and ceramics. The soft magnetic layer 12 is formed into a thin film by sputtering a soft magnetic material. The intermediate layer 13 is a layer that functions as an underlayer for forming the magnetic layer 14, and is formed into a thin film by sputtering an intermediate layer forming material. As described above, the magnetic layer 14 is a layer with a thickness of around 18 nm that constructs the concave/convex patterns 25 (data track patterns 25t and servo patterns 25sa shown in FIGS. 3, 4), and has plural concaves 27 formed therein by an etching process carried out on a layer produced by sputtering a magnetic material. Note that on the magnetic disk 10A, as one example, the concave/convex patterns 25 are formed so that the depths of the concaves 27 (i.e., the distances along the thickness direction from the protruding end surfaces of the convexes 26 to the bottom surfaces of the concaves 27) that construct the data track patterns 25t and the servo patterns 25sa are both 10 nm.

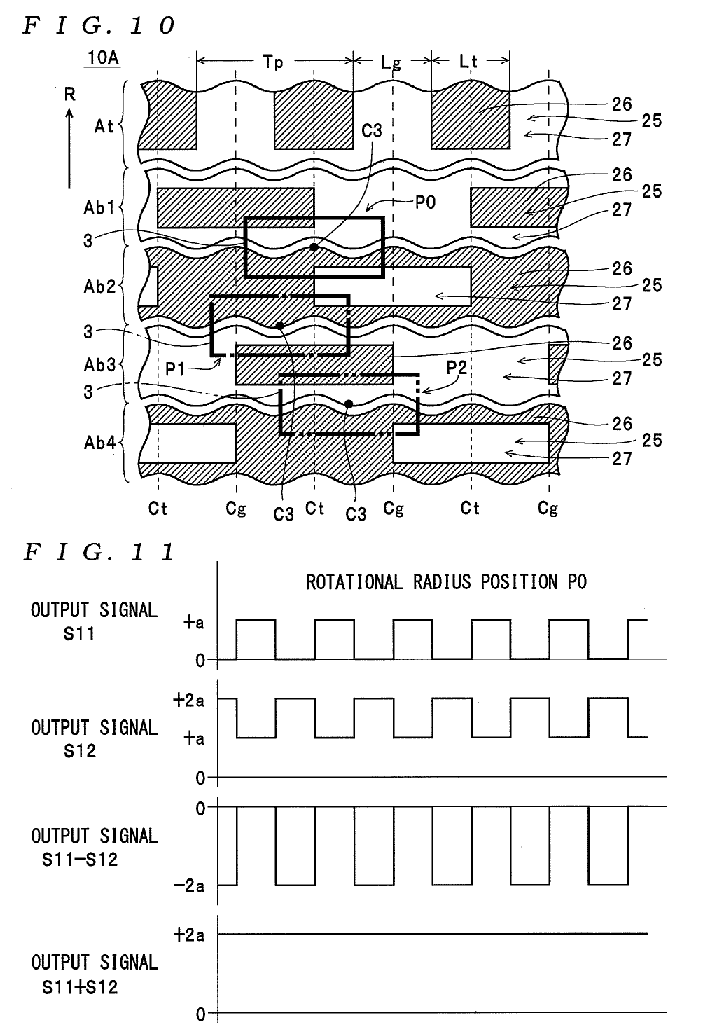

Here, as shown in FIGS. 3 and 4, on the magnetic disk 10A, the servo pattern regions Asa are provided between the data recording regions At, At that are adjacent in the direction of rotation (the direction of the arrow R) and the data recording regions At and the servo pattern regions Asa are set so as to alternate in the direction of rotation. Also, the data track patterns 25t are formed by the concave/convex patterns 25 described above (one example of first concave/convex patterns for the present invention) in the data recording regions At. Note that in FIGS. 3 and 4 and in FIGS. 10 and 14 to 18 referred to later, the regions that are diagonally shaded represent regions in the concave/convex patterns 25 where the convexes 26 are formed and the white regions represent the regions in the concave/convex patterns 25 where concaves 27 are formed. Here, the data track patterns 25t are formed of plural concentric or spiral convexes 26 (data recording tracks) that are centered on the center of the magnetic disk 10A and the concaves 27 (inter-track concaves) between the convexes 26, 26. Note that although it is preferable for the center of rotation of the magnetic disk 10A and the pattern center of the data track patterns 25t to match, in reality due to manufacturing errors, there are cases where an extremely small displacement of around a few μm is produced between the center of rotation and the pattern center of the magnetic disk 10A. However, since tracking servo control of the magnetic head 3 will still be sufficiently possible for a displacement of this size, the center of rotation and the pattern center can be said to be effectively the same.

As one example, the data track patterns 25t are formed so that the length Lt of the convexes 26 (the data recording tracks) along the radial direction of the magnetic disk 10A is equal to the length Lg along the radial direction of the concaves 27 (as one example, length Lt=length Lg=50 nm: track pitch Tp=100 nm) and the length Lt along the radial direction of the convexes 26 and the length Lg along the radial direction of the concaves 27 are substantially the same length from an inner periphery region to an outer periphery region of the magnetic disk 10A. Accordingly, on the magnetic disk 10A, the ratio of the total area of the concaves 27 in a concave/convex pattern 25 that constructs a data track pattern 25t to the total area of the convexes 26 in the concave/convex pattern 25 that constructs the data track pattern 25t is “1:1”, that is, the value of the ratio between concaves and convexes of the data track patterns 25t (a value produced by dividing the total area of the convexes 26 in a concave/convex pattern 25 that constructs a data track pattern 25t by the total area of the concaves 27 in the concave/convex pattern 25 that constructs the data track pattern 25t) is “1/1=1”.

On the other hand, as shown in FIGS. 3 and 4, in the servo pattern regions Asa, the servo patterns 25sa are formed by the concave/convex patterns 25 described above (one example of second concave/convex patterns for the present invention). More specifically, as shown in FIG. 4, in each servo pattern region Asa, a servo pattern 25sa is formed so as to include a preamble pattern formed by the concave/convex pattern 25 in the preamble pattern region Ap, an address pattern formed by the concave/convex pattern 25 in the address pattern region Aa, a burst pattern formed by the concave/convex pattern 25 in the burst pattern region Aba, and the like. Note that for ease of understanding the present invention, description of servo regions aside from the preamble pattern regions Ap, the address pattern regions Aa, and the burst pattern regions Aba has been omitted.

On the magnetic disk 10A, in the same way as in the preamble portion of the conventional disk medium, the concave/convex pattern 25 is formed so that the length along the direction of rotation of the convexes 26 in the preamble pattern region Ap is around 50% of the repeated period in which a convex 26 and a concave 27 are present. This means that on the magnetic disk 10A, the length along the direction of rotation of the convexes 26 that construct the preamble pattern and the length along the direction of rotation of the concaves 27 will be the same at the positions with an equal radius (i.e., positions with the same rotational radius). Accordingly, on the magnetic disk 10A, the ratio of the total area of the concaves 27 to the total area of the convexes 26 in the preamble pattern region Ap is “1:1” (the value of the ratio between concaves and convexes of the concave/convex pattern 25 that constructs the preamble pattern is “1/1=1”). Also, on the magnetic disk 10A, in the same way as in the address portion on the conventional disk medium, the total area of the convexes 26 to the total area of the concaves 27 in an address pattern region Aa (that is, the respective numbers of “ones” and “zeros” in the address data code) are substantially equal. Accordingly, on the magnetic disk 10A, the ratio of the total area of the concaves 27 to the total area of the convexes 26 in the address pattern region Aa is substantially “1:1” (the value of the ratio between concaves and convexes of the concave/convex patterns 25 that construct the address pattern is substantially “1/1=1”).

Also, as shown in FIG. 3, four burst regions composed of a first burst region Ab1 where the respective burst signal unitary parts (unitary signal regions that are quadrangular when viewed from above) are formed of convexes 26, a second burst region Ab2 where the respective burst signal unitary parts are formed of concaves 27, a third burst region Ab3 where the respective burst signal unitary parts are formed of convexes 26, and a fourth burst region Ab4 where the respective burst signal unitary parts are formed of concaves 27 are aligned in the mentioned order along the direction of rotation of the magnetic disk 10A in each burst pattern region Aba. Note that on the magnetic disk 10A, the four burst regions composed of the first burst region Ab1 to the fourth burst region Ab4 respectively correspond to N burst regions for the present invention (one example where “N=4”).

Note that in the embodiments of the present invention described in this specification, like the four burst regions composed of the first burst region Ab1 (A burst), the second burst region Ab2 (B burst), the third burst region Ab3 (C burst), and the fourth burst region Ab4 (D burst) on the magnetic disk 10A for example, “a region where patterns, in which plural burst signal unitary parts, whose inner periphery end portions in the radial direction (the direction of the radius for rotation) match in the direction of rotation and whose outer periphery end portions in the radial direction match in the direction of rotation, are aligned along the direction of rotation, are aligned in the radial direction” is regarded as being “one burst region”. Also, within a region where the respective burst signal unitary parts are formed so that the inner periphery end portions and/or outer periphery end portions of the burst signal unitary parts match in the direction of rotation, a region where the burst signal unitary parts are formed of convexes 26 and a region where the burst signal unitary parts are formed of concaves 27 are regarded as being different burst regions.

Here, on the magnetic disk 10A, as one example, the lengths along the direction of rotation of the first burst region Ab1 to the fourth burst region Ab4 are set so as to be equal at positions with the same radius. Patterns for detecting the head position in order to keep the magnetic head 3 on-track to a desired track are formed in the first burst region Ab1 to the fourth burst region Ab4. More specifically, a burst pattern BP1a for detecting a track center (center Ct) of a data track pattern 25t is formed in the first burst region Ab1 and the second burst region Ab2, and a burst pattern BP2a for detecting a center (center Cg) of an inter-track concave of the data track pattern 25t is formed in the third burst region Ab3 and the fourth burst region Ab4.

Also, in the first burst region Ab1, the burst signal unitary parts of the burst pattern BP1a are formed of convexes 26 and in the second burst region Ab2, the burst signal unitary parts of the burst pattern BP1a are formed of concaves 27. Accordingly, on the magnetic disk 10A, in the first burst region Ab1, regions where plural convexes 26 are formed along the direction of rotation (the direction of the arrow R) and where the convexes 26 and the concaves 27 alternate in the direction of rotation and regions where a concave 27 is continuous in the direction of rotation are provided so as to alternate in the radial direction, and in the second burst region Ab2, regions where plural concaves 27 are formed along the direction of rotation (the direction of the arrow R) and where the convexes 26 and the concaves 27 alternate along the direction of rotation, and regions where a convex 26 is continuous in the direction of rotation are provided so as to alternate in the radial direction.

Also, in the third burst region Ab3, the burst signal unitary parts (burst signal regions that are quadrangular when viewed from above) of the burst pattern BP2a are formed of convexes 26 and in the fourth burst region Ab4, the burst signal unitary parts of the burst pattern BP1a are formed of concaves 27. Accordingly, on the magnetic disk 10A, in the third burst region Ab3, regions where plural convexes 26 are formed along the direction of rotation (the direction of the arrow R) and where the convexes 26 and the concaves 27 alternate along the direction of rotation and regions where a concave 27 is continuous in the direction of rotation are provided so as to alternate in the radial direction, and in the fourth burst region Ab4, regions where plural concaves 27 are formed along the direction of rotation (the direction of the arrow R) and where the convexes 26 and the concaves 27 alternate along the direction of rotation and regions where a convex 26 is continuous in the direction of rotation are provided so as to alternate in the radial direction.

In this case, on the magnetic disk 10A, the burst patterns BP1a, BP2a are formed so that burst regions where the burst signal unitary parts are constructed of concaves 27 (the second burst region Ab2 and the fourth burst region Ab4) and burst regions where the burst signal unitary parts are constructed of convexes 26 (the first burst region Ab1 and the third burst region Ab3) alternate in the direction of rotation, the two regions composed of the second burst region Ab2 and the fourth burst region Ab4 correspond to M burst regions for the present invention (an example where “M=2”), and the two regions composed of the first burst region Ab1 and the third burst region Ab3 correspond to L burst regions for the present invention (an example where “L=2”). Also, in the respective burst regions from the first burst region Ab1 to the fourth burst region Ab4, the servo patterns 25sa (burst patterns BP1a, BP2a) are formed so that plural burst signal unitary parts are formed so as to be aligned along the direction of rotation so that the lengths thereof along the radial direction are equal (in this example, so that the lengths along the radial direction are all 200 nm), so that the inner periphery end portions in the radial direction of the respective burst signal unitary parts formed at positions with the same radius match in the direction of rotation, and so that the outer periphery end portions in the radial direction of the respective burst signal unitary parts formed at positions with the same radius match in the direction of rotation.

Note that although a state where four burst signal unitary parts are formed so as to be aligned in the direction of rotation in each of the first burst region Ab1 to the fourth burst region Ab4 is shown in FIG. 3, in reality, as one example, fourteen burst signal unitary parts are formed so as to be aligned in the direction of rotation in each of the first burst region Ab1 to the fourth burst region Ab4. Also, as one example, the formation period (formation pitch along the direction of rotation) of the burst signal unitary parts in each of the first burst region Ab1 to the fourth burst region Ab4 is around 140 nm at positions with a radius (a radius of rotation) of 14 mm and is around 180 nm at positions with a radius of 18 mm. In addition, as one example, the length along the direction of rotation of the burst signal unitary parts in each of the first burst region Ab1 to the fourth burst region Ab4 is around 70 nm at positions with a radius of 14 mm and is around 90 nm at positions with a radius of 18 mm.

Also, on the magnetic disk 10A, the ratio of the total area of the concaves 27 formed inside the first burst region Ab1 to the total area of the convexes 26 (burst signal unitary parts) formed inside the first burst region Ab1 and the ratio of the total area of the concaves 27 formed inside the third burst region Ab3 to the total area of the convexes 26 (burst signal unitary parts) formed inside the third burst region Ab3 are both “3:1” (the values of the ratios between concaves and convexes of the concave/convex pattern 25 inside the first burst region Ab1 and the concave/convex pattern 25 inside the third burst region Ab3 are both “1/3”). In addition, on the magnetic disk 10A, the ratio of the total area of the concaves 27 (burst signal unitary parts) formed inside the second burst region Ab2 to the total area of the convexes 26 formed inside the second burst region Ab2 and the ratio of the total area of the concaves 27 (burst signal unitary parts) formed inside the fourth burst region Ab4 to the total area of the convexes 26 formed inside the fourth burst region Ab4 are both “1:3” (the values of the ratios between concaves and convexes of the concave/convex pattern 25 inside the second burst region Ab2 and the concave/convex pattern 25 inside the fourth burst region Ab4 are both “3/1”). Accordingly, on the magnetic disk 10A, the ratio of the total area of the concaves 27 formed inside the burst pattern regions Aba to the total area of the convexes 26 formed inside the burst pattern regions Aba is “1:1” (the values of the ratios between concaves and convexes of the burst patterns BP1a, BP2a are both “1/1=1”).

The method of manufacturing the magnetic disk 10A will be described next.

A preform 20 and a stamper 30 shown in FIG. 5 are used when manufacturing the magnetic disk 10A described above. Here, the preform 20 is constructed by forming the soft magnetic layer 12, the intermediate layer 13, and the magnetic layer 14 in the mentioned order on the glass base plate 11, with an A mask layer 21 also being formed on the magnetic layer 14. In this case, a B mask layer 22 is also formed on the A mask layer 21 of the preform 20. Note that as one example, the B mask layer 22 is formed by applying a resin material onto the A mask layer 21. Since the method of forming the B mask layer 22 is well known, detailed description thereof is omitted.

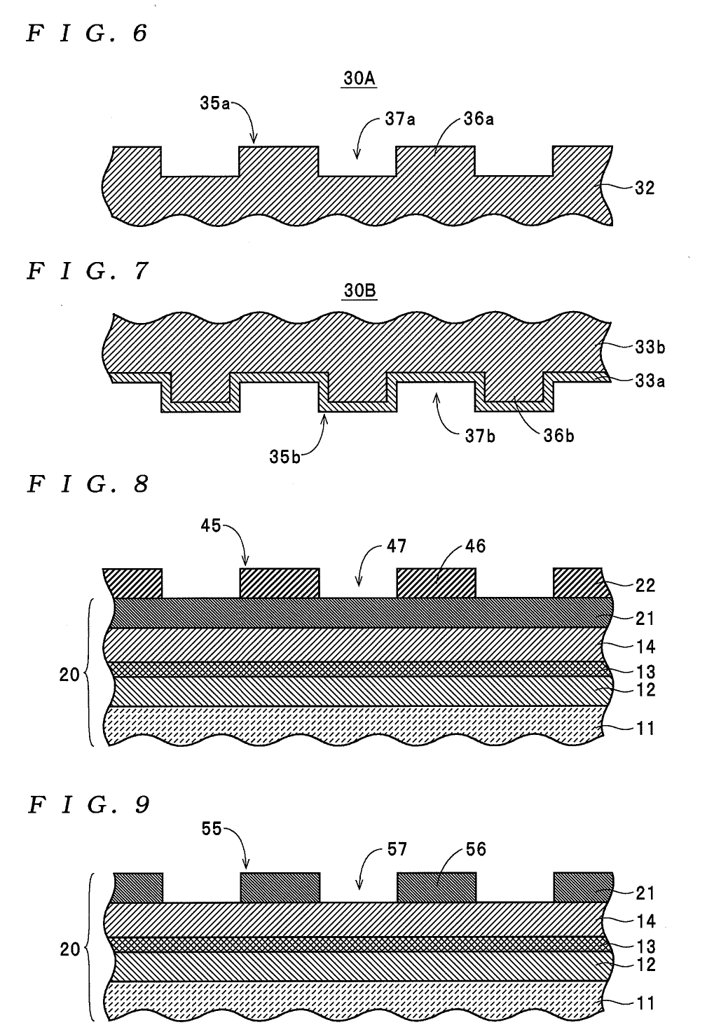

On the other hand, the stamper 30 is one example of a stamper according to the present invention and is formed in a disk shape using a resin material 31 by carrying out an injection molding process using a stamper 30A shown in FIG. 6. The stamper 30 has a concave/convex pattern 35 which is capable of forming a concave/convex pattern 45 (see FIG. 8) for forming the concave/convex patterns 25 (the data track patterns 25t and the servo patterns 25sa) of the magnetic disk 10A formed thereupon, and is constructed so as to be capable of manufacturing the magnetic disk 10A by imprinting. The concave/convex pattern 35 of the stamper 30 is one example of a stamper-side concave/convex pattern for the present invention and has convexes 36 (one example of stamper-side convexes for the present invention) formed corresponding to concaves 27 in the concave/convex patterns 25 of the magnetic disk 10A and concaves 37 (one example of stamper-side concaves for the present invention) formed corresponding to convexes 26 of the concave/convex pattern 25 of the magnetic disk 10A (an example where “one of the concaves and the convexes” for the present invention refers to concaves and stamper-side convexes are formed corresponding to such concaves and where “another of the concaves and the convexes” for the present invention refers to convexes and stamper-side concaves are formed corresponding to such convexes).

In this case, on the magnetic disk 10A manufactured using the stamper 30, as described earlier, in all of the data recording regions At and the servo pattern regions Asa (the preamble pattern region Ap, the address pattern region Aa, and the burst pattern region Aba), the concave/convex patterns 25 (the data track patterns 25t and the servo patterns 25sa) are formed so that the value of the ratio between concaves and convexes (i.e., the total area of the convexes 26 relative to the total area of the concaves 27) is “1/1=1”. Accordingly, on the stamper 30 on which the concave/convex pattern 35 is formed corresponding to the concave/convex patterns 25, in the regions that respectively correspond to the data recording regions At and the servo pattern regions Asa of the magnetic disk 10A, the values of the ratios between convexes and concaves (the total area of the concaves 37 relative to the total area of the convexes 36, that is, values produced by dividing the total area of the concaves 37 by the total area of the convexes 36) will be around “1/1=1”.

The stamper 30A described above is another example of a stamper according to the present invention and is formed in a disk shape of nickel 32 by an electroplating process (a nickel plating process) that uses the stamper 3013 shown in FIG. 7. The concave/convex pattern 35a of the stamper 30A is another example of a stamper-side concave/convex pattern for the present invention, and has convexes 36a (another example of stamper-side convexes for the present invention) formed corresponding to the convexes 26 in the concave/convex patterns 25 of the magnetic disk 10A (the concaves 37 of the stamper 30 described above) and concaves 37a (another example of stamper-side concaves for the present invention) formed corresponding to concaves 27 in the concave/convex patterns 25 (to the convexes 36 of the stamper 30 described above) (In this example, “one of the concaves and the convexes” for the present invention refers to convexes and stamper-side convexes are formed corresponding to such convexes and “another of the concaves and the convexes” for the present invention refers to concaves and stamper-side concaves are formed corresponding to such concaves).

In addition, the stamper 30B described above is yet another example of a stamper according to the present invention, and is formed in an overall disk shape by forming a layer of nickel 33b by an electroplating process that uses a thin film of nickel 33a formed on a support base, not shown, as an electrode. A concave/convex pattern 35b of the stamper 30B is yet another example of a stamper-side concave/convex pattern for the present invention, and has convexes 36b (yet another example of stamper-side convexes for the present invention) formed corresponding to the concaves 27 (the concaves 37a of the stamper 30A described above) in the concave/convex patterns 25 of the magnetic disk 10A and concaves 37b (yet another example of stamper-side concaves for the present invention) formed corresponding to the convexes 26 (the convexes 36a of the stamper 30A described above) in the concave/convex patterns 25 (In this example, “one of concaves and convexes” for the present invention refers to concaves and stamper-side convexes are formed corresponding to such concaves and where “another of concaves and convexes” for the present invention refers to convexes and stamper-side concaves are formed corresponding to such convexes). Note that since the method of manufacturing the stampers 30, 30A, 30B is well known, detailed description thereof is omitted.

First, the concave/convex pattern 35 of the stamper 30 is transferred onto the B mask layer 22 on the preform 20 by imprinting. More specifically, by pressing the surface of the stamper 30 on which the concave/convex pattern 35 is formed onto the B mask layer 22 on the preform 20, the convexes 36 of the concave/convex pattern 35 are pressed into the B mask layer 22 on the preform 20. When doing so, as described above, since the values of the ratios between convexes and concaves of the respective regions of the stamper 30 are equal, it is easy to press the convexes 36 into the B mask layer 22 substantially uniformly across the entire stamper 30. By doing so, the resin material (the B mask layer 22) at positions where the convexes 36 of the stamper 30 are pressed in moves inside the concaves 37 of the concave/convex pattern 35, and by separating the stamper 30 from the preform 20, the concaves 47 are formed as shown in FIG. 8.

Note that in reality, although extremely thin resin material (B mask layer 22: hereinafter also referred to as “residue”) will remain between the protruding end surfaces of the convexes 36 of the stamper 30 and the A mask layer 21 of the preform 20 (i.e., at the bottom surfaces of the concaves 47), such material has been omitted from FIG. 8. Next, by removing the residue on the bottom surfaces of the concaves 47 by carrying out an oxygen plasma process, the concave/convex pattern 45 composed of plural concaves 47, and convexes 46 (the B mask layer 22) between the concaves 47, 47 is formed on the A mask layer 21 of the preform 20.

Next, by carrying out an etching process using the concave/convex pattern 45 (B mask layer 22) described above as a mask, the A mask layer 21 exposed from the mask (the convexes 46) is etched at the bottom positions of the concaves 47 in the concave/convex pattern 45. By doing so, as shown in FIG. 9, a concave/convex pattern 55 including plural convexes 56 corresponding to the convexes 46 of the concave/convex pattern 45 and plural concaves 57 corresponding to the concaves 47 of the concave/convex pattern 45 is formed on the magnetic layer 14 (i.e., in the A mask layer 21) of the preform 20. Next, by carrying out an etching process using the concave/convex pattern 55 (the A mask layer 21) as a mask, the magnetic layer 14 exposed from the mask (the convexes 56) at the bottom portions of the concaves 57 in the concave/convex pattern 55 is etched to form the plural concaves 27 with a depth of 10 nm in the magnetic layer 14. By doing so, the concave/convex patterns 25 (the data track patterns 25t and the servo patterns 25sa) that include the plural convexes 26 and the plural concaves 27 are formed.

After this, a thin-film of diamond-like carbon (DLC) is deposited by CVD on the magnetic layer 14 so as to cover the concave/convex patterns 25 and thereby form the protective layer 15. Next, a lubricant is applied onto the surface of the protective layer 15. By doing so, the magnetic disk 10A is completed as shown in FIG. 2. Next, by housing the completed magnetic disk 10A in a case together with the magnetic head 3 and the like, the hard disk drive 1 is completed.

In the hard disk drive 1, as described earlier, the detection unit 4 detects servo signals based on the output signal S1 from the magnetic head 3 in accordance with control by the control unit 6, and the detection result is outputted to the control unit 6 as the detection signal S2. On the other hand, based on the output signal S1 obtained from the first burst region Ab1 in the burst pattern regions Aba and the detection signal S2 outputted from the detection unit 4 corresponding to the output signal S1 obtained from the second burst region Ab2, the control unit 6 specifies the positional displacement of the magnetic head 3 from the track center (the center Ct shown in FIG. 3). Also, based on the output signal S1 obtained from the third burst region Ab3 and the detection signal S2 outputted from the detection unit 4 corresponding to the output signal S1 obtained from the fourth burst region Ab4, the control unit 6 specifies the positional displacement of the magnetic head 3 from the center of an inter-track concave (the center Cg shown in FIG. 3). In addition, the control unit 6 controls the driver 5 in accordance with the specified positional displacements and moves the magnetic head 3 to a desired radial position.

Here, in the hard disk drive 1 equipped with the magnetic disk 10A, as one example, the output signal S1 from the magnetic head 3 becomes a high value when the convexes 26 that construct the burst signal unitary parts of the first burst region Ab1 or the third burst region Ab3 pass below the magnetic head 3 and the output signal S1 from the magnetic head 3 becomes a low value when the concaves 27 between the convexes 26 that construct the burst signal unitary parts pass below the magnetic head 3. Also, in the hard disk drive 1, the output signal S1 from the magnetic head 3 becomes a low value when the concaves 27 that construct the burst signal unitary parts of the second burst region Ab2 or the fourth burst region Ab4 pass below the magnetic head 3 and the output signal S1 from the magnetic head 3 becomes a high value when the convexes 26 between the concaves 27 that construct the burst signal unitary parts pass below the magnetic head 3.

More specifically, in a state where the reproducing element of the magnetic head 3 is located at a radial position P0 as shown by a solid line in FIG. 10 (a state where the center C3 in the read width direction of the magnetic head 3 coincides with the center Ct), when the first burst region Ab1 passes below the magnetic head 3, as shown in FIG. 11, a +aV output signal S1 is outputted corresponding to the burst signal unitary parts (convexes 26) and a 0V output signal S1 is outputted corresponding to the concaves 27 between the burst signal unitary parts (hereinafter, the output signal S1 when the first burst region Ab1 is passed is also referred to as the output signal S11). Also, in a state where the magnetic head 3 is located at the radial position P0, when the second burst region Ab2 passes below the magnetic head 3, a +aV output signal S1 is outputted corresponding to the burst signal unitary parts (concaves 27) and a +2aV output signal S1 is outputted corresponding to the convexes 26 between the burst signal unitary parts (hereinafter, the output signal S1 when the second burst region Ab2 is passed is also referred to as the output signal S12).

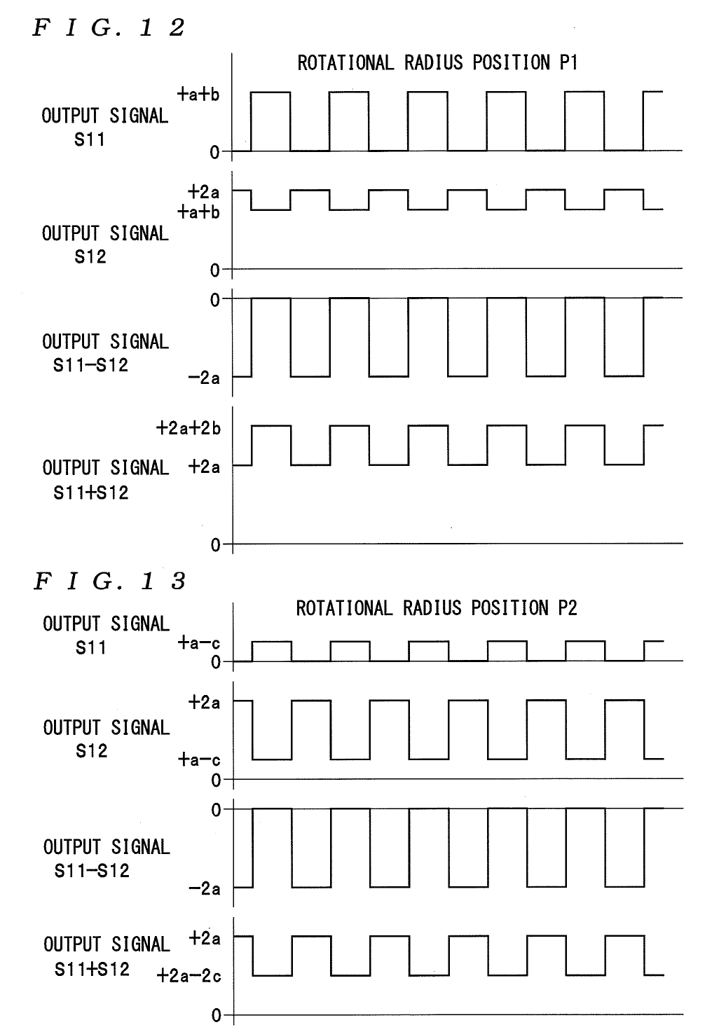

Also, in a state where the reproducing element of the magnetic head 3 is located at a radial position P1 as shown by a dot-dash line in FIG. 10 (a state where the magnetic head 3 is displaced from a state where the center C3 in the read width direction of the magnetic head 3 coincides with the center Ct towards a direction where the magnetic head 3 increasingly overlaps the burst signal unitary parts of the first burst region Ab1), when the first burst region Ab1 passes below the magnetic head 3, as shown in FIG. 12, a +a+bV output signal S11 is outputted corresponding to the burst signal unitary parts (convexes 26) and a 0V output signal S11 is outputted corresponding to the concaves 27 between the burst signal unitary parts. Also, in a state where the magnetic head 3 is located at the radial position P1, when the second burst region Ab2 passes below the magnetic head 3, a +a+bV output signal S12 is outputted corresponding to the burst signal unitary parts (concaves 27) and a +2aV output signal S12 is outputted corresponding to the convexes 26 between the burst signal unitary parts.

In addition, in a state where the reproducing element of the magnetic head 3 is located at a radial position P2 as shown by a dot-dot-dash line in FIG. 10 (a state where the magnetic head 3 is displaced from a state where the center C3 in the read width direction of the magnetic head 3 coincides with the center Ct towards a direction where the magnetic head 3 increasingly overlaps with the burst signal unitary parts of the second burst region Ab2), when the first burst region Ab1 passes below the magnetic head 3, as shown in FIG. 13, a +a−cV output signal S11 is outputted corresponding to the burst signal unitary parts (convexes 26) and a 0V output signal S11 is outputted corresponding to the concaves 27 between the burst signal unitary parts. Also, in a state where the magnetic head 3 is located at the radial position P2, when the second burst region Ab2 passes below the magnetic head 3, a +a−cV output signal S12 is outputted corresponding to the burst signal unitary parts (concaves 27) and a +2aV output signal S12 is outputted corresponding to the convexes 26 between the burst signal unitary parts.

This means that both in a state where the center C3 of the magnetic head 3 matches the center Ct (a state where the center C3 is located at radial position P0) and in a state where the center C3 of the magnetic head 3 is displaced from the center Ct (a state where the center C3 is located at radial positions such as P1, P2), as shown in FIGS. 11 to 13 the output signal S11-S12 will have the same value (in this example, a rectangular wave whose voltage fluctuates between −2aV and 0V). On the other hand, the output signal S11+S12 will be a different value in accordance with the radial position of the magnetic head 3. More specifically, although the output signal S11+S12 will have a constant value of +2aV as shown in FIG. 11 in a state where the magnetic head 3 is located at the radial position P0, in a state where the magnetic head 3 is located at the radial position P1, the output signal S11+S12 is a rectangular wave where the voltage fluctuates between +2av and +2a+2bV as shown in FIG. 12, and in a state where the magnetic head 3 is located at the radial position P2, the output signal S11+S12 is a rectangular wave where the voltage fluctuates between +2a−2cV and +2aV as shown in FIG. 13.

In this case, as described above, since the output signal S11-S12 has the same value (in this example, a rectangular wave whose voltage fluctuates between −2aV and 0V, the control unit 6 principally specifies the displacement of the magnetic head 3 from the center Ct based on the detection signal S2 outputted corresponding to the output signal S11+S12 described above. In this way, when the burst signal unitary parts differ between concaves and convexes in burst regions that form a pair such as the first burst region Ab1 and the second burst region Ab2 (i.e., burst regions that construct one burst pattern), a PES (Position Error Signal) may be calculated based on the sum of the output signals obtained from the respective burst regions (in the example described above, the “output signal S11+S12”). Note that although a method that specifies the positional displacement from the center Ct based on the detection signal S2 corresponding to the first burst region Ab1 and the second burst region Ab2 (the burst pattern BP1a) has been described, it is also possible to specify the positional displacement of the magnetic head 3 from the center Cg according to the same principle described above based on the output signals S1 corresponding to the third burst region Ab3 and the fourth burst region Ab4 (the burst pattern BP2a). Accordingly, the control unit 6 controls the driver 5 having specified the present radial position of the magnetic head 3 based on the detection signal S2 from the detection unit 4 and in accordance with this, the driver 5 controls the actuator 3b to position the magnetic head 3 at a desired radial position on the magnetic disk 10A.

Here, as described earlier, on the magnetic disk 10A provided in the hard disk drive 1, the concave/convex patterns 25 (the data track patterns 25t and the servo patterns 25sa) are formed so that in all of the data recording regions At and the servo pattern regions Asa (the preamble pattern regions Ap, the address pattern regions Aa, and the burst pattern regions Aba), the value of the ratio between concaves and convexes (the total area of the convexes 26 relative to the total area of the concaves 27) is “1/1=1”. Accordingly, unlike the conventional disk medium where there is a large difference in the flying height of the head between a state where a burst portion is not located below the magnetic head and a state where a burst portion is located below the magnetic head, with the magnetic disk 10A provided in the hard disk drive 1, the flying height of the magnetic head 3 is substantially equal in both a state where a burst pattern region Aba is not located below the magnetic head 3 and a state where a burst pattern region Aba is located below the magnetic head 3.

In this way, on the magnetic disk 10A, the burst pattern regions Aba are constructed of N burst regions (in the above example, four regions composed of the first burst region Ab1 to the fourth burst region Ab4) in which burst patterns BP1a, BP2a, in which plural burst signal unitary parts are aligned along the direction of rotation, are formed as servo patterns, the burst signal unitary parts formed in M(=2) out of the N(=4) burst regions Ab1 to Ab4 (in this example, two regions, i.e., in the second burst region Ab2 and the fourth burst region Ab4) are constructed of concaves 27, and the burst signal unitary parts formed in L(=2) out of the N(=4) burst regions Ab1 to Ab4 (in this example, two regions, i.e., in the first burst region Ab1 and the third burst region Ab3) are constructed of convexes 26. Such magnetic disk 10A is also included in the hard disk drive 1.

Therefore, according to the magnetic disk 10A and the hard disk drive 1 equipped with the magnetic disk 10A, since it is possible to sufficiently reduce the difference between the head flying height between a state where a burst pattern region Aba is not located below the magnetic head 3 (slider) and the head flying height in a state where a burst pattern region Aba is located below the magnetic head 3 (slider), it is possible to sufficiently reduce the fluctuation in the flying height of the magnetic head 3 per revolution of the magnetic disk 10A. By doing so, according to the magnetic disk 10A and the hard disk drive 1 equipped with the magnetic disk 10A, it is possible to prevent the occurrence of head crashes and favorably avoid damage to the magnetic disk 10A and the magnetic head 3.

Also, according to the magnetic disk 10A and the hard disk drive 1 equipped with the magnetic disk 10A, by setting the value of M (in this example “2”) for the present invention and the value of L (in this example “2”) for the present invention so that the ratio of the area of the concaves 27 in the concave/convex patterns 25 (the servo patterns 25sa) that construct the burst patterns BP1a, BP2a to the area of the convexes 26 in the concave/convex pattern 25 (the servo patterns 25sa) that construct the burst patterns BP1a, BP2a is as close as possible to the ratio (“1:1”) of the area of the concaves 27 in the concave/convex patterns 25 (the data track patterns 25t) that construct the data track patterns and the area of the convexes 26 in the concave/convex patterns 25 that construct the data track patterns (i.e., so that the values of the ratios between concaves and convexes of the servo patterns 25sa that construct the burst patterns BP1a, BP2a are as close as possible to the values of the ratios between concaves and convexes (“1/1=1”) of the data track patterns 25t), it is possible to significantly reduce the difference between the flying height of the head in a state where a burst pattern region Aba is not located below the magnetic head 3 (slider) and the flying height of the head in a state where a burst pattern region Aba is located below the magnetic head 3 (slider). This means it is possible to significantly reduce the flying height of the magnetic head 3 per revolution of the magnetic disk 10A. By doing so, according to the magnetic disk 10A and the hard disk drive 1 equipped with the magnetic disk 10A, it is possible to reliably prevent head crashes from occurring.

In addition, according to the magnetic disk 10A and the hard disk drive 1 equipped with the magnetic disk 10A, by forming the burst patterns BP1a, BP2a so that burst regions where the burst signal unitary parts are composed of concaves 27 (in this example, the second burst region Ab2 and the fourth burst region Ab4) and burst regions where the burst signal unitary parts are composed of convexes 26 (in this example, the first burst region Ab1 and the third burst region Ab3) alternate in the direction of rotation, it is possible to sufficiently reduce the extent to which the concaves 27 and the convexes 26 are unbalanced inside the burst pattern regions Aba. More specifically, according to the magnetic disk 10A and the hard disk drive 1 equipped with the magnetic disk 10A, it is possible to make the flying height of the head in a state where only the first burst region Ab1 and the second burst region Ab2 out of the four burst regions Ab1 to Ab4 in the burst pattern regions Aba are located below the magnetic head 3 (slider) and the flying height of the head in a state where all of the four burst regions Ab1 to Ab4 are located below the magnetic head 3 (slider) due to rotation of the magnetic disk 10A substantially equal. Therefore, according to the magnetic disk 10A and the hard disk drive 1 equipped with the magnetic disk 10A, it is possible to significantly reduce the fluctuation in the flying height of the magnetic head 3 per revolution of the magnetic disk 10A. By doing so, it is possible to reliably prevent the occurrence of head crashes.

Also, according to the stamper 30 for manufacturing the magnetic disk 10A, by forming the concave/convex pattern 35 that includes the convexes 36 formed corresponding to one of the concaves 27 and the convexes 26 (in this example, the concaves 27) of the concave/convex patterns 25 (the data track patterns 25t and the servo patterns 25sa) of the magnetic disk 10A described above and the concaves 37 formed corresponding to the other of the concaves 27 and the convexes 26 (in this example, the convexes 26), it is possible to manufacture the magnetic disk 10A described above. Also, according to the stamper 30, since there is sufficiently reduced fluctuation in the ratios in the respective regions, such as regions corresponding to the data recording regions and regions corresponding to the burst pattern regions, between the total area of the respective regions of the convexes 36 formed corresponding to the concaves 27 in the concave/convex patterns 25 of the magnetic disk 10A and the total area of the respective regions of the concaves 37 formed corresponding to the convexes 26 in the concave/convex patterns 25 (i.e., the total area in the respective regions of the concaves 37 relative to the total area of the respective regions of the convexes 36: the values of the ratios between convexes and concaves of the respective regions in the concave/convex pattern 35), when the concave/convex pattern 35 of the stamper 30 is transferred to the B mask layer 22 on the preform 20 by imprinting when manufacturing the magnetic disk 10A, it will be easy to uniformly press in the convexes 36 across the entire range of the stamper 30. This means that it is possible to form the concave/convex pattern 45 (mask pattern) used when etching the magnetic layer 14 with high precision.

In addition, according to the stamper 30A described above, since the concave/convex pattern 35a is formed with the concaves 37a corresponding to the concaves 27 of the concave/convex patterns 25 (the data track patterns 25t and the servo patterns 25sa) of the magnetic disk 10A described above and the convexes 36a corresponding to the convexes 26, it is possible to manufacture the stamper 30 described above. Also, according to the stamper 30B described above, since the concave/convex pattern 35b is formed with the convexes 36b corresponding to the concaves 27 of the concave/convex patterns 25 (the data track patterns 25t and the servo patterns 25sa) of the magnetic disk 10A described above and the concaves 37b corresponding to the convexes 26, it is possible to manufacture the stamper 30A described above.

Next, examples of hard disk drives 1 equipped with a magnetic disk 10B that is another example of a magnetic recording medium according to the present invention and a magnetic disk 10C that is yet another example of a magnetic recording medium according to the present invention will be described with reference to the drawings. Note that component elements of the magnetic disks 10B, 10C and magnetic disks 10D to 10I that are the same as in the magnetic disk 10A described earlier and the hard disk drive 1 equipped with the magnetic disk 10A have been assigned the same reference numerals and duplicated description thereof is omitted. Also, since the method of manufacturing the magnetic disks 10B to 10I and the construction and method of manufacturing the stampers manufactured in accordance with such disks are the same as the method of manufacturing the magnetic disk 10A described above and the constructions and the methods of manufacturing the stampers 30, 30A, 30B manufactured corresponding to the magnetic disk 10A, description and illustration thereof are omitted.

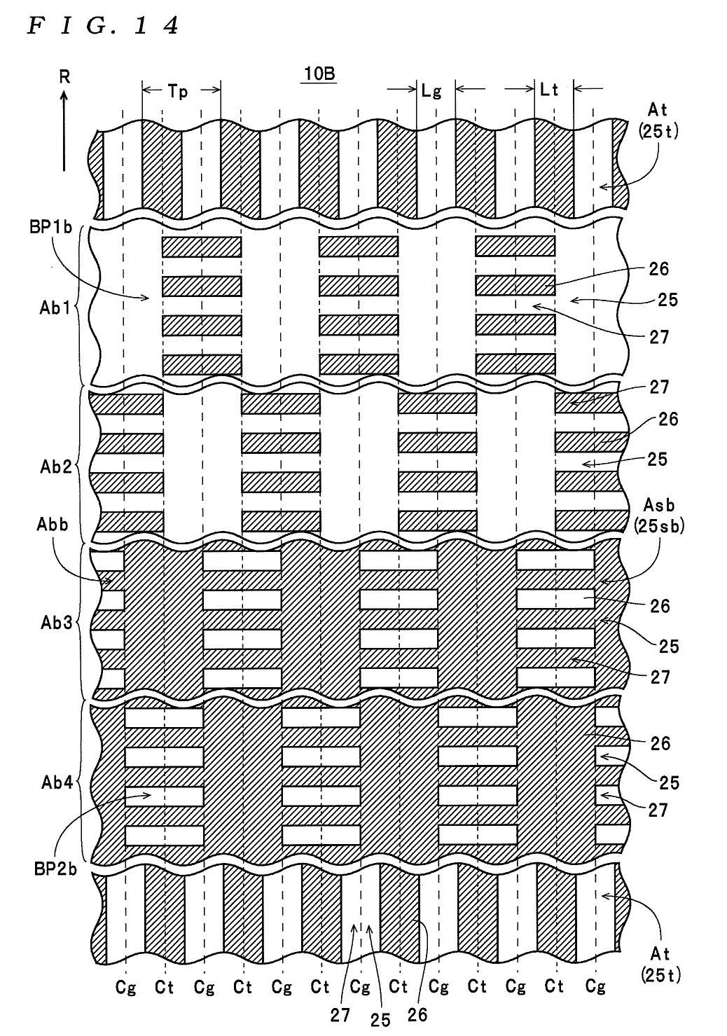

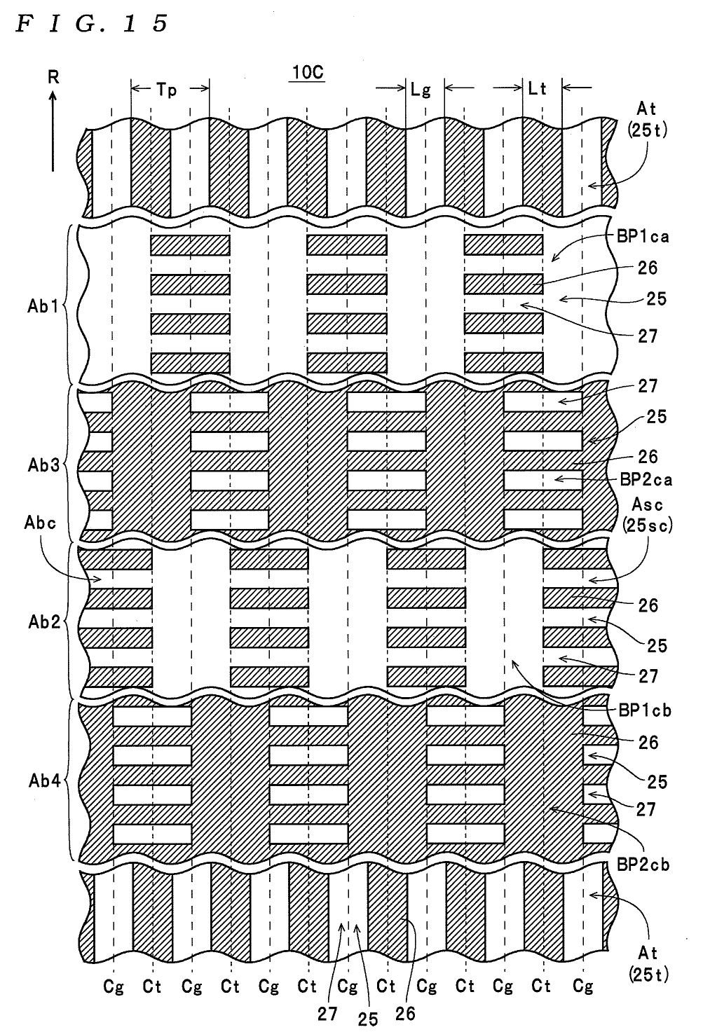

As shown in FIG. 14, the magnetic disk 10B has servo patterns 25sb formed inside servo pattern regions Asb in place of the servo patterns 25sa of the magnetic disk 10A described earlier. Also, as shown in FIG. 15, the magnetic disk 10C has servo patterns 25sc formed inside servo pattern regions Asc in place of the servo patterns 25sa of the magnetic disk 10A described earlier.

In this case, four burst regions, which are composed of the first burst region Ab1 and the second burst region Ab2 where the burst signal unitary parts (unitary signal regions that are quadrangular when viewed from above) are formed of convexes 26 and the third burst region Ab3 and the fourth burst region Ab4 where the burst signal unitary parts are formed of concaves 27, are aligned in the mentioned order along the direction of rotation of the magnetic disk 10B in each burst pattern region Abb of the servo pattern regions Asb on the magnetic disk 10B. Note that on the magnetic disk 10B, the four burst regions composed of the first burst region Ab1 to the fourth burst region Ab4 correspond to the N burst regions for the present invention (an example where “N=4”). In this case, the burst pattern BP1b is formed in the first burst region Ab1 and the second burst region Ab2 and the burst pattern BP2b is formed in the third burst region Ab3 and the fourth burst region Ab4. Also, on the magnetic disk 10B, the two regions composed of the third burst region Ab3 and the fourth burst region Ab4 correspond to M burst regions for the present invention (an example where “M=2”), and the two regions composed of the first burst region Ab1 and the second burst region Ab2 correspond to L burst regions for the present invention (an example where “L=2”).

Although the magnetic disk 10A described earlier and the magnetic disk 10B described above are constructed so that the first burst region Ab1 and the second burst region Ab2, in which the burst patterns BP1a, BP1b for detecting positional displacement of the magnetic head 3 from the center Ct are formed, are consecutive in the direction of rotation, and the third burst region Ab3 and the fourth burst region Ab4, in which the burst patterns BP2a, BP2b for detecting positional displacement of the magnetic head 3 from the center Cg are formed, are also consecutive in the direction of rotation, the construction of the magnetic recording medium according to the present invention is not limited to this. For example, on the magnetic disk 10C, four burst regions Ab1 to Ab4 are set inside the burst pattern regions Abc so that the first burst region Ab1 and the second burst region Ab2 are separated by having the third burst region Ab3 disposed therebetween in the direction of rotation and the third burst region Ab3 and the fourth burst region Ab4 are separated by having the second burst region Ab2 disposed therebetween in the direction of rotation. Note that on the magnetic disk 10C, the four burst regions composed of the first burst region Ab1 and the fourth burst region Ab4 correspond to N burst regions for the present invention (an example where “N=4”).

Burst patterns BP1ca, BP1cb where the burst signal unitary parts (unitary signal regions that are quadrangular when viewed from above) are formed of convexes 26 are formed in the first burst region Ab1 and the second burst region Ab2 of each servo pattern region Asc on the magnetic disk 10C and burst patterns BP2ca, BP2cb where the burst signal unitary parts (unitary signal regions that are quadrangular when viewed from above) are formed of the concaves 27 are formed in the third burst region Ab3 and the fourth burst region Ab4. In this case, on the magnetic disk 10C, the burst patterns BP1ca, BP1cb described above together function as the same type of pattern as the burst patterns BP1a, BP1b of the magnetic disks 10A, 10B described earlier, and the burst patterns BP2ca, BP2cb described above together function as the same type of pattern as the burst patterns BP2a, BP2b of the magnetic disks 10A, 10B described earlier.

Also, the burst patterns BP1ca, BP2ca, BP1cb, BP2cb are formed on the magnetic disk 10C so that burst regions (the third burst region Ab3 and the fourth burst region Ab4) where the burst signal unitary parts are constructed of concaves 27 and burst regions (the first burst region Ab1 and the second burst region Ab2) where the burst signal unitary parts are constructed of convexes 26 alternate in the direction of rotation, the two burst regions composed of the third burst region Ab3 and the fourth burst region Ab4 correspond to M burst regions for the present invention (an example where “M=2”), and the two burst regions composed of the first burst region Ab1 and the second burst region Ab2 correspond to L burst regions for the present invention (one example where “L=2”).

In this case, on the magnetic disk 10B (10C), the ratio of the total area of the concaves 27 formed inside the first burst region Ab1 to the total area of the convexes 26 (burst signal unitary parts) formed inside the first burst region Ab1 and the ratio of the total area of the concaves 27 formed inside the second burst region Ab2 to the total area of the convexes 26 (burst signal unitary parts) formed inside the second burst region Ab2 are both “3:1” (i.e., the values of the ratios between concaves and convexes of the concave/convex pattern 25 inside the first burst region Ab1 and the concave/convex pattern 25 inside the second burst region Ab2 are both “1/3”). In addition, on the magnetic disk 10B (10C), the ratio of the total area of the concaves 27 (burst signal unitary parts) formed inside the third burst region Ab3 to the total area of the convexes 26 formed inside the third burst region Ab3 and the ratio of the total area of the concaves 27 (burst signal unitary parts) formed inside the fourth burst region Ab4 to the total area of the convexes 26 formed inside the fourth burst region Ab4 are both “1:3” (i.e., the values of the ratios between concaves and convexes of the concave/convex pattern 25 inside the third burst region Ab3 and the concave/convex pattern 25 inside the fourth burst region Ab4 are both “3/1”).

Accordingly, on the magnetic disk 10B, the ratio of the total area of the concaves 27 formed in the burst pattern regions Abb to the total area of the convexes 26 formed in the burst pattern regions Abb is “1:1” (i.e., the values of the ratios between concaves and convexes of the burst patterns BP1b, BP2b are “1/1=1”). Also, on the magnetic disk 10C, the ratio of the total area of the concaves 27 formed in the burst pattern regions Abc and the total area of the convexes 26 formed in the burst pattern regions Aba is “1:1” (i.e., the values of the ratios between concaves and convexes of the burst patterns BP1ca, BP1cb, BP2ca, BP2cb are all “1/1=1”).

For this reason, in the same way as the magnetic disk 10A described earlier, in all of the data recording regions At and the servo pattern regions Asb (Asc) (the preamble pattern regions Ap, the address pattern regions Aa, and the burst pattern regions Abb (Abc)) on the magnetic disks 10B (10C), the ratio of the total area of the concaves 27 to the total area of the convexes 26 is “1:1” (the value of the ratio between concaves and convexes of the concave/convex pattern 25: the total area of the convexes 26 relative to the total area of the concaves 27 is “1/1=1”). Accordingly, in a hard disk drive 1 equipped with the magnetic disk 10B (10C), the flying height of the magnetic head 3 will be substantially the same in both a state where a burst pattern region Abb (Abc) is not located below the magnetic head 3 and a state where a burst pattern region Abb (Abc) is located below the magnetic head 3.

As described above, according to the magnetic disk 10B (10C) and the hard disk drive 1 equipped with the magnetic disk 10B (10C), in the same way as the magnetic disk 10A and the hard disk drive 1 equipped with the magnetic disk 10A described earlier, since it is possible to sufficiently reduce the difference between the head flying height between a state where a burst pattern region Abb (Abc) is not located below the magnetic head 3 (slider) and the head flying height in a state where a burst pattern region Abb (Abc) is located below the magnetic head 3 (slider), it is possible to sufficiently reduce the fluctuation in the flying height of the magnetic head 3 per revolution of the magnetic disk 10B (10C). By doing so, according to the magnetic disk 10B (10C) and the hard disk drive 1 equipped with the magnetic disk 10B (10C), it is possible to prevent the occurrence of head crashes and favorably avoid damage to the magnetic disk 10B (10C) and the magnetic head 3.

Note that when the burst signal unitary parts are all convexes or all concaves in a pair of burst regions (in this example, “the first burst region Ab1 and second burst region Ab2” and the “third burst region Ab3 and fourth burst region Ab4”) as on the magnetic disks 10B, 10C, the PES may be calculated based on the difference between the output signals obtained from the respective burst regions (for example, the “output signal S11-S12” described earlier). More specifically, on the magnetic disks 10B, 10C described above, in the first burst region Ab1 and the second burst region Ab2 in which the burst signal unitary parts are formed of the convexes 26, the PES may be calculated according to the same procedure as the method of calculating the PES for a conventional magnetic disk where the burst signal unitary parts are formed of only convexes, while in the third burst region Ab3 and the fourth burst region Ab4 in which the burst signal unitary parts are formed of the concaves 27, the PES may be calculated according to the same procedure as the method of calculating the PES for a conventional magnetic disk where the burst signal unitary parts are formed of only concaves.

The present inventors prepared the magnetic disks 10A to 10C described above, a magnetic disk (hereinafter, also referred to as the “magnetic disk 10x1”: not shown) where the burst signal unitary parts are formed of convexes 26 in all of the burst regions Ab1 to Ab4 in the same way as a conventional disk medium, a magnetic disk (hereinafter, also referred to as the “magnetic disk 10x2”: not shown) where the burst signal unitary parts are formed of concaves 27 in all of the burst regions Ab1 to Ab4 in the same way as another conventional disk medium, and a continuous magnetic layer-type magnetic disk (a magnetic disk where the surface where the data track patterns and servo patterns are formed is smooth: hereinafter also referred to as the “magnetic disk 10x3”: not shown) with the same diameter as the above magnetic disks, and measured the fluctuation value in the flying height of the magnetic head 3 for each of the magnetic disks 10A to 10C and the 10x1 to 10x3.

Note that the magnetic disks 10A to 10C and 10x1 to 10x3 prepared for such measurements were formed so that the planar form and size of the data track patterns and the servo patterns are the same and so that on the magnetic disks 10A to 10C, 10x1, and 10x2, the depths of the concaves 27 are equal at 10 nm. Also, as the magnetic head for measuring the fluctuation in the flying height, two types of magnetic head, specifically a magnetic head (hereinafter also referred to as the “magnetic head A”) with a slider that was designed and fabricated so that the head flying height is 15 nm when the magnetic disk 10x3 is rotated at a constant velocity of 3600 rpm and a magnetic head (hereinafter also referred to as the “magnetic head B”) with a slider that is designed and fabricated so that the head flying height is 10 nm, were prepared.

In addition, as one example, the fluctuation in the flying height of the magnetic head was measured according to the conditions listed below using a combination of the “AT3600” and “AT0042” Laser Doppler Vibrometers made by GRAPHTEC, and a “He-Ne laser” with a wavelength of 632.8 nm was used as a laser light source.

### Measurement Conditions

Rotational Velocity of Magnetic Disk: 3600 rpm

Measurement Position Radial Position=16 mm

Measurement Frequency: 40 to 200 kHz

Velocity Range: 10⁻¹ m/s/V

Displacement Range: 10⁻⁷ m/V

Measurement was carried out by shining laser light onto a rear surface of the slider.

In this case, on the magnetic disk 10x3 where no concaves and convexes are present on the disk surface, when either of the magnetic heads A, B were used, the fluctuation in the flying height per revolution of the magnetic disk 10x3 (i.e., the difference between the highest and lowest positions of the magnetic head per revolution) was 2 nm. On the other hand, on the magnetic disk 10x1 and the magnetic disk 10x2, head crashes occurred when both the magnetic heads A, B were used, and it was not possible to measure the fluctuation in the flying height. On the other hand, with the magnetic disks 10A to 10C, the fluctuation in the flying height when the magnetic head A was used was equal to the magnetic disk 10x3 at 2 nm. With the magnetic disks 10A, 10C, the fluctuation in the flying height when the magnetic head B was used was also equal to the magnetic disk 10x3 at 2 nm. With the magnetic disk 10B, the fluctuation in the flying height when the magnetic head B was used was slightly larger than the magnetic disk 10x3 at 4 nm. Accordingly, it can be understood that on the magnetic disks 10A to 10C where the burst signal unitary parts are formed of concaves 27 in two out of the four burst regions Ab1 to Ab4 and the burst signal unitary parts are formed of convexes 26 in the other two burst regions, the fluctuation in the flying height can be reduced to an extremely small value that is substantially equal to the magnetic disk 10x3 that has no concaves and convexes present on the disk surface.

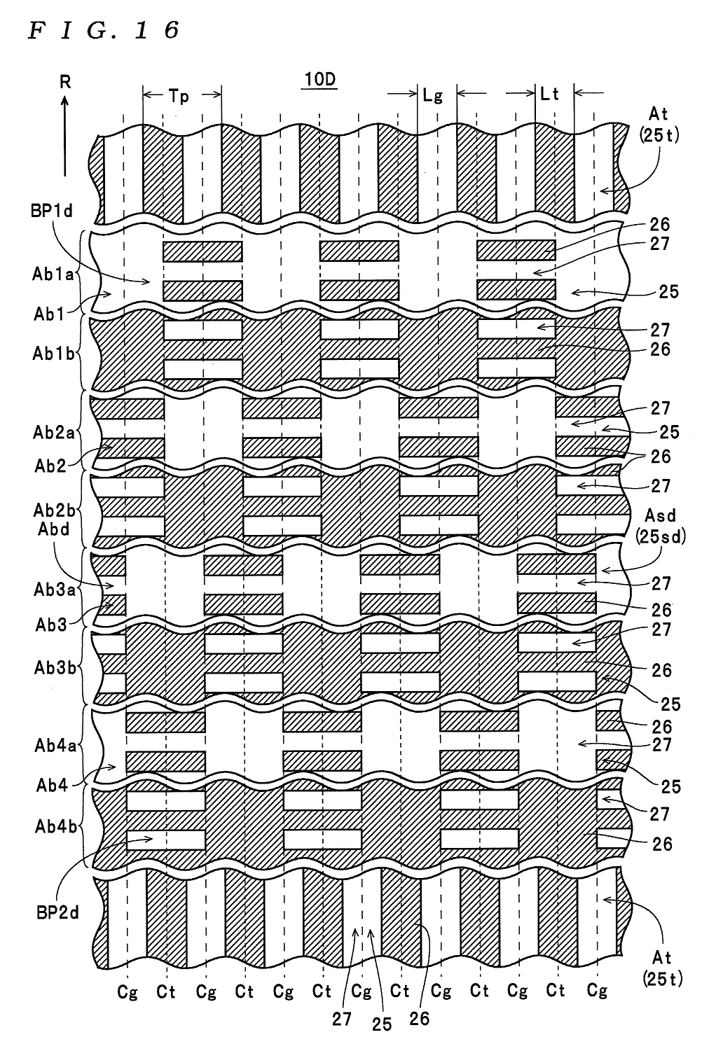

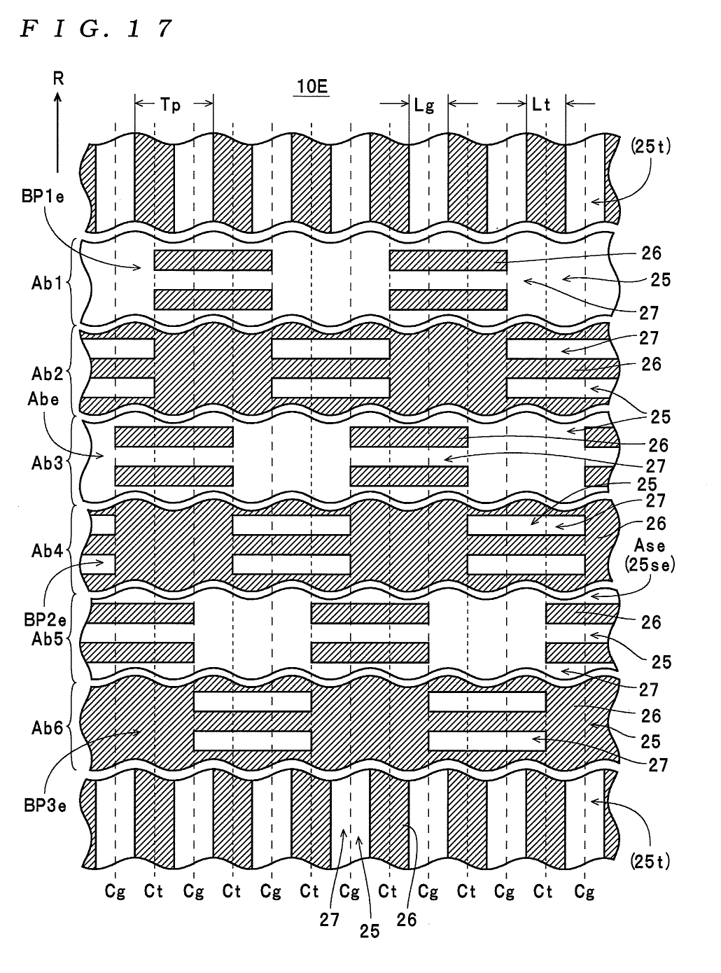

Note that the present invention is not limited to the constructions described above. As one example, on the magnetic disks 10A to 10C described earlier, it is possible to use a construction where the positional displacement of the magnetic head 3 with respect to the center Ct is detected according to the concave/convex patterns 25 (burst pattern) formed in the first burst region Ab1 and the second burst region Ab2 and the positional displacement of the magnetic head 3 with respect to the center Cg is detected according to the concave/convex patterns 25 (burst pattern) formed in the third burst region Ab3 and the fourth burst region Ab4. On the other hand, on a magnetic disk 10D shown in FIG. 16, a construction is used where two burst regions Ab1a, Ab1b construct the first burst region Ab1, two burst regions Ab2a, Ab2b construct the second burst region Ab2, two burst regions Ab3a, Ab3b construct the third burst region Ab3, and two burst regions Ab4a, Ab4b construct the fourth burst region Ab4, a positional displacement of the magnetic head 3 with respect to the center Ct is detected using the concave/convex patterns 25 (burst pattern BP1d) formed in the first burst region Ab1 and the second burst region Ab2, and a positional displacement of the magnetic head 3 with respect to the center Cg is detected using the concave/convex patterns 25 (burst pattern BP2d) formed in the third burst region Ab3 and the fourth burst region Ab4.

On this magnetic disk 10D, servo patterns 25sd are formed in servo pattern regions Asd in place of the servo patterns 25sa and the like of the magnetic disk 10A described earlier. Also, in each servo pattern region Asd, the burst signal unitary parts (unitary signal regions that are quadrangular when viewed from above) are formed of convexes 26 in four regions composed of the burst region Ab1a of the first burst region Ab1, the burst region Ab2a of the second burst region Ab2, the burst region Ab3a of the third burst region Ab3, and the burst region Ab4a of the fourth burst region Ab4. In addition, in each servo pattern region Asd, the burst signal unitary parts (unitary signal regions that are quadrangular when viewed from above) are formed of concaves 27 in four regions composed of the burst region Ab1b of the first burst region Ab1, the burst region Ab2b of the second burst region Ab2, the burst region Ab3b of the third burst region Ab3, and the burst region Ab4b of the fourth burst region Ab4.

Here, on the magnetic disk 10D, the eight burst regions Ab1a to Ab4a, Ab1b to Ab4b correspond to N burst regions for the present invention. Also, on the magnetic disk 10D, the burst patterns BP1d, BP2d are formed so that burst regions (burst regions Ab1b to Ab4b) where the burst signal unitary parts are constructed of the concaves 27 and burst regions (burst regions Ab1a to Ab4a) where the burst signal unitary parts are constructed of the convexes 26 alternate in the direction of rotation, the four burst regions Ab1b to Ab4b correspond to M burst regions for the present invention (an example where “M=4”), and the four burst regions Ab1a to Ab4a correspond to L burst regions for the present invention (an example where “L=4”). Note that on the magnetic disk 10D, as one example, the length along the direction of rotation of the burst region Ab1a and the length along the direction of rotation of the burst region Ab1b are set equal at positions with the same radius, the length along the direction of rotation of the burst region Ab2a and the length along the direction of rotation of the burst region Ab2b are set equal at positions with the same radius, the length along the direction of rotation of the burst region Ab3a and the length along the direction of rotation of the burst region Ab3b are set equal at positions with the same radius, and the length along the direction of rotation of the burst region Ab4a and the length along the direction of rotation of the burst region Ab4b are set equal at positions with the same radius.

Note that on the magnetic disk 10D, as one example, by calculating a first PES based on the output signal obtained from the burst region Ab1a and the output signal obtained from the burst region Ab2a, calculating a second PES based on the output signal obtained from the burst region Ab1b and the output signal obtained from the burst region Ab2b, and using the average of the two PES as a PES, it is possible to specify the head position of the magnetic head 3 in the radial direction.

Also, on the magnetic disk 10D, the ratio of the total area of the concaves 27 formed inside the burst region Ab1a to the total area of the convexes 26 (burst signal unitary parts) formed inside the burst region Ab1a, the ratio of the total area of the concaves 27 formed inside the burst region Ab2a to the total area of the convexes 26 (burst signal unitary parts) formed inside the burst region Ab2a, the ratio of the total area of the concaves 27 formed inside the burst region Ab3a to the total area of the convexes 26 (burst signal unitary parts) formed inside the burst region Ab3a, and the ratio of the total area of the concaves 27 formed inside the burst region Ab4a to the total area of the convexes 26 (burst signal unitary parts) formed inside the burst region Ab4a are all “3:1” (the values of the ratios between concaves and convexes of the concave/convex patterns 25 inside the burst regions Ab1a, Ab2a, Ab3a, Ab4a are all “1/3”).

In addition, on the magnetic disk 10D, the ratio of the total area of the concaves 27 (burst signal unitary parts) formed inside the burst region Ab1b to the total area of the convexes 26 formed inside the burst region Ab1b, the ratio of the total area of the concaves 27 (burst signal unitary parts) formed inside the burst region Ab2b to the total area of the convexes 26 formed inside the burst region Ab2b, the ratio of the total area of the concaves 27 (burst signal unitary parts) formed inside the burst region Ab3b to the total area of the convexes 26 formed inside the burst region Ab3b, and the ratio of the total area of the concaves 27 (burst signal unitary parts) formed inside the burst region Ab4b to the total area of the convexes 26 formed inside the burst region Ab4b are all “1:3” (the values of the ratios between concaves and convexes of the concave/convex patterns 25 inside the burst regions Ab1b, Ab2b, Ab3b, Ab4b are all “3/1=3”). Accordingly, on the magnetic disk 10D, the ratio of the total area of the concaves 27 formed inside the burst pattern region Abd to the total area of the convexes 26 formed inside the burst pattern region Abd is “1:1” (the values of the ratios between concaves and convexes of the burst patterns BP1d, BP2d are “1/1=1”).

On the other hand, on the magnetic disk 10E shown in FIG. 17, servo patterns 25se are formed in servo pattern regions Ase in place of the servo patterns 25sa and the like of the magnetic disk 10A described earlier. Also, burst signal unitary parts (unitary signal regions that are quadrangular when viewed from above) are formed of convexes 26 in three regions composed of the first burst region Ab1, the third burst region Ab3, and a fifth burst region Ab5 in each servo pattern region Ase. In addition, burst signal unitary parts (unitary signal regions that are quadrangular when viewed from above) are formed of concaves 27 in three regions composed of the second burst region Ab2, the fourth burst region Ab4, and a sixth burst region Ab6 in each servo pattern region Ase. Here, the magnetic disk 10E uses a construction where in place of the burst patterns BP1a, BP2a and the like of the magnetic disk 10A described earlier, the positional displacements of the magnetic head 3 from the centers Ct, Cg are detected using three burst patterns composed of a burst pattern BP1e formed in the first burst region Ab1 and the second burst region Ab2, a burst pattern BP2e formed in the third burst region Ab3 and the fourth burst region Ab4, and a burst pattern BP3e formed in the fifth burst region Ab5 and the sixth burst region Ab6.

On the magnetic disk 10E, the six burst regions composed of the first burst region Ab1 to the sixth burst region Ab6 correspond to N burst regions for the present invention. Also, on the magnetic disk 10E, the burst patterns BP1e to BP3e are formed so that burst regions in which the burst signal unitary parts are constructed of concaves 27 (the second burst region Ab2, the fourth burst region Ab4, and the sixth burst region Ab6) and burst regions in which the burst signal unitary parts are constructed of convexes 26 (the first burst region Ab1, the third burst region Ab3, and the fifth burst region Ab5) alternate in the direction of rotation, the three burst regions composed of the second burst region Ab2, the fourth burst region Ab4, and the sixth region Ab6 correspond to M burst regions for the present invention (an example where “M=3”) and the three burst regions composed of the first burst region Ab1, the third burst region Ab3, and the fifth burst region Ab5 correspond to L burst regions for the present invention (an example where “L=3”).

In addition, on the magnetic disk 10E, the ratio of the total area of the concaves 27 formed in the first burst region Ab1 to the total area of the convexes 26 (burst signal unitary parts) formed in the first burst region Ab1, the ratio of the total area of the concaves 27 formed in the third burst region Ab3 to the total area of the convexes 26 (burst signal unitary parts) formed in the third burst region Ab3, and the ratio of the total area of the concaves 27 formed in the fifth burst region Ab5 to the total area of the convexes 26 (burst signal unitary parts) formed in the fifth burst region Ab5 are all “3:1” (the respective values of the ratios between concaves and convexes of the concave/convex pattern 25 in the first burst region Ab1, the concave/convex pattern 25 inside the third burst region Ab3, and the concave/convex pattern 25 in the fifth burst region Ab5 are all “1/3”).

In addition, on the magnetic disk 10E, the ratio of the total area of the concaves 27 (burst signal unitary parts) formed in the second burst region Ab2 to the total area of the convexes 26 formed in the second burst region Ab2, the ratio of the total area of the concaves 27 (burst signal unitary parts) formed in the fourth burst region Ab4 to the total area of the convexes 26 formed in the fourth burst region Ab4, and the ratio of the total area of the concaves 27 (burst signal unitary parts) formed in the sixth burst region Ab6 to the total area of the convexes 26 formed in the sixth burst region Ab6 are all “1:3” (the respective values of the ratios between concaves and convexes of the concave/convex pattern 25 in the second burst region Ab2, the concave/convex pattern 25 inside the fourth burst region Ab4, and the concave/convex pattern 25 in the sixth burst region Ab6 are all “3/1”). Accordingly, on the magnetic disk 10E, the ratio of the total area of the concaves 27 formed inside the burst pattern region Abe to the total area of the convexes 26 formed inside the burst pattern region Abe is “1:1” (the values of the ratios between concaves and convexes of the burst patterns BP1e, BP2e, BP3e are all “1/1=1”).

For this reason, on the magnetic disk 10D (10E) described above, in the same way as the magnetic disk 10A and the like described earlier, in all the data recording regions At and the servo pattern regions Asd (Ase) (the preamble pattern regions Ap, the address pattern regions Aa, and the burst pattern regions Abd (Abe)), the ratio of the total area of the concaves 27 to the total area of the convexes 26 is “1:1” (the value of the ratio between concaves and convexes of the concave/convex pattern 25: the total area of the convexes 26 relative to the total area of the concaves 27 is “1/1=1”). Accordingly, in the hard disk drive 1 equipped with the magnetic disk 10D (10E), the flying height of the magnetic head 3 is substantially equal in both a state where a burst pattern region Abd (Abe) is not located below the magnetic head 3 and a state where a burst pattern region Abd (Abe) is located below the magnetic head 3.

Here, on the magnetic disks 10A to 10E described above, since the ratio of the total area of the concaves 27 in the data recording regions At to the total area of the convexes 26 in the data recording regions At is “1:1” (the value of the ratio between concaves and convexes of the data track patterns 25t is “1/1=1”), the respective values of “M” and “L” are set at the same value to make the “ratio of the area of the concaves in the second concave/convex patterns that construct the burst patterns to the area of the convexes in the second concave/convex patterns that construct the burst patterns (the values of the ratios between concaves and convexes of the concave/convex patterns 25 that construct the burst patterns)” as close as possible to “1/1=1”. On the other hand, when the ratio of the total area of the concaves 27 in the data recording regions At to the total area of the convexes 26 in the data recording regions At is not “1:1” (i.e., when the value of the ratio between concaves and convexes of the data track patterns 25t is not “1/1=1”), the values of “M” and “L” for the present invention are respectively set in accordance with such ratio (value).

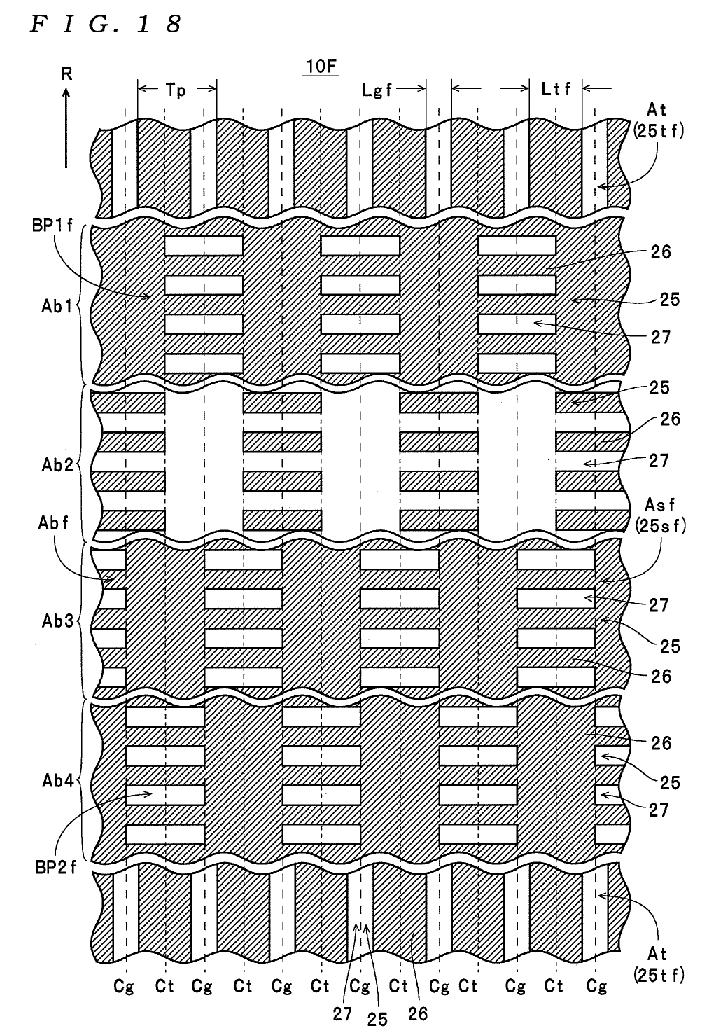

More specifically, on the magnetic disk 10F shown in FIG. 18, for example, data track patterns 25tf are formed inside the data recording regions At so that the formation pitch (track pitch Tp) along the radial direction of the convexes 26 (data recording tracks) inside the data recording regions At is the same as on the magnetic disks 10A to 10E and the ratio of the length Lgf along the radial direction of the concaves 27 (the concaves between the data recording tracks) to the length Ltf along the radial direction of the convexes 26 (data recording tracks) is “Lgf:Ltf=1:2”, for example. Accordingly, on the magnetic disk 10F, the ratio of the total area of the concaves 27 in the concave/convex patterns 25 that construct the data track patterns 25tf to the total area of the convexes 26 in the concave/convex patterns 25 that construct the data track patterns 25tf is “1:2” (the value of the ratio between concaves and convexes of the data track patterns 25tf is “2/1=2”).

On the magnetic disk 10F, servo patterns 25sf are formed in the servo pattern regions Asf in place of the servo patterns 25sa and the like of the magnetic disk 10A described earlier. Here, the burst pattern region Abf of the servo pattern regions Asf is provided with four burst regions composed of the first burst region Ab1 to the fourth burst region Ab4 that are aligned along the direction of rotation (an example where “N=4”), and burst patterns BP1f, BP2f are formed by concave/convex patterns 25. Burst signal unitary parts (unitary signal regions that are quadrangular when viewed from above) are formed of concaves 27 in three regions composed of the first burst region Ab1, the third burst region Ab3, and the fourth burst region Ab4 in each servo pattern region Asf, and burst signal unitary parts (unitary signal regions that are quadrangular when viewed from above) are formed of convexes 26 in the second burst region Ab2 in each servo pattern region Asf. Here, on the magnetic disk 10F, the three regions composed of the first burst region Ab1, the third burst region Ab3, and the fourth burst region Ab4 correspond to M burst regions for the present invention (an example where “M=3”), and only the second burst region Ab2 corresponds to L burst regions for the present invention (an example where “L=1”).

On the magnetic disk 10F, the ratio of the total area of the concaves 27 formed in the first burst region Ab1 to the total area of the convexes 26 (burst signal unitary parts) formed in the first burst region Ab1, the ratio of the total area of the concaves 27 (burst signal unitary parts) formed in the third burst region Ab3 to the total area of the convexes 26 formed in the third burst region Ab3, and the ratio of the total area of the concaves 27 (burst signal unitary parts) formed in the fourth burst region Ab4 to the total area of the convexes 26 formed in the fourth burst region Ab4 are all “1:3” (the values of the ratios between concaves and convexes of the concave/convex pattern 25 in the first burst region Ab1, the concave/convex pattern 25 in the third burst region Ab3, and the concave/convex pattern 25 in the fourth burst region Ab4 are all “3/1”). In addition, on the magnetic disk 10F, the ratio of the total area of the concaves 27 (burst signal unitary parts) formed in the second burst region Ab2 to the total area of the convexes 26 formed in the second burst region Ab2 is “3:1” (the value of the ratio between concaves and convexes of the concave/convex pattern 25 in the second burst region Ab2 is “1/3”).

Accordingly, on the magnetic disk 10F, the ratio of the total area of the concaves 27 formed in the burst pattern region Abf to the total area of the convexes 26 formed in the burst pattern region Abf is “1·(3/4)+3·(1/4):1·(1/4)+3·(3/4)=6:10” (the values of the ratios between concaves and convexes of the burst patterns BP1f, BP2f are both “10/6”), which is as close as possible to the ratio “1:2” of the total area of the concaves 27 in a concave/convex pattern 25 that constructs a data track pattern 25tf to the total area of the convexes 26 in a concave/convex pattern 25 that constructs a data track pattern 25tf (the value of the ratio between concaves and convexes of the data track patterns 25tf is “2/1”). Here, if the values “M” and “L” for the present invention were both set at “2” in the same way as on the magnetic disk 10A or the like described earlier, the ratio of the total area of the concaves 27 in the burst pattern region Abf to the total area of the convexes 26 in the burst pattern region Abf would be “1:1” (the value of the ratio between concaves and convexes of the concave/convex pattern 25 that constructs the burst pattern would be “1/1=1”), which greatly differs to the ratio “1:2” of the total area of the concaves 27 of the data track patterns 25tf to the total area of the convexes 26 of the data track patterns 25tf (the value of the ratio between concaves and convexes “2/1” of the data track patterns 25tf).

Accordingly, on the magnetic disk 10F, as described above by setting the value of “M” for the present invention at “3” and the value of “L” for the present invention at “1”, the ratio of the total area of the concaves 27 to the total area of the convexes 26 in the burst pattern regions Abf (the values of the ratios between concaves and convexes of the burst patterns BP1f, BP2f) is set at a value that is as close as possible to the ratio of the total area of the concaves 27 to the total area of the convexes 26 in the data recording regions At (the value of the ratio between concaves and convexes of the data track patterns 25tf). By doing so, according to the hard disk drive 1 equipped with the magnetic disk 10F, since it is possible to significantly reduce the difference between the head flying height in a state where a burst pattern region Abf is not located below the magnetic head 3 (slider) and the head flying height in a state where a burst pattern region Abf is located below the magnetic head 3 (slider), it is possible to significantly reduce the fluctuation in the flying height of the magnetic head 3 per revolution of the magnetic disk 10F. This means that according to the magnetic disk 10F and the hard disk drive 1 that is equipped with the magnetic disk 10F, it is possible to reliably prevent the occurrence of head crashes.

Here, although the values of M and L for the present invention are set on the magnetic disks 10A to 10F described above so that the ratio of the area of the concaves 27 in the concave/convex patterns 25 (the second concave/convex patterns) that construct the burst patterns to the area of the convexes 26 in the concave/convex patterns 25 that construct the burst patterns is as close as possible to the ratio of the area of the concaves 27 in the concave/convex patterns 25 (the first concave/convex patterns) that construct the data track patterns to the area of the convexes 26 in the concave/convex patterns 25 that construct the data track patterns, the present invention is not limited to this. In accordance with the flying characteristics of the magnetic head (head slider) and the diameter, expected rotational velocity, and the like of the magnetic disk, the values of M and L for the present invention may be set according to a method aside from the method given above, such as the method described below.

More specifically, as one example, it is possible to set the values of M and L for the present invention so that the ratio of the area of the concaves 27 in the concave/convex patterns 25 that construct the servo patterns (i.e., the concave/convex patterns 25 formed in the preamble pattern region Ap, the address pattern region Aa, and the burst pattern regions Ab: the second concave/convex patterns) to the area of the convexes 26 in the concave/convex patterns 25 that construct the servo patterns is as close as possible to the ratio of the area of the concaves 27 in the concave/convex patterns 25 that construct the data track patterns (i.e., the concave/convex patterns 25 formed in the data recording regions At: the first concave/convex patterns) to the area of the convexes 26 in the concave/convex patterns 25 that construct the data track patterns. By using this construction, since it is possible to sufficiently reduce the difference between the head flying height in a state where a servo pattern region is not located below the magnetic head 3 (slider) and the head flying height in a state where a servo pattern region is located below the magnetic head 3 (slider), it is possible to sufficiently reduce the fluctuation in the flying height of the magnetic head 3 per revolution of the magnetic disk (magnetic recording medium). By doing so, it is possible to reliably prevent the occurrence of head crashes.

It is also possible to set the values of M and L for the present invention so that the ratio of the area of the concaves 27 of the concave/convex patterns 25 that construct the burst patterns (concave/convex patterns 25 formed in the burst pattern regions Ab: the second concave/convex patterns) to the area of the convexes 26 of the concave/convex patterns 25 that construct the burst patterns is as close as possible to the ratio of (i) the total of the area of the concaves 27 in the concave/convex patterns 25 (the concave/convex patterns 25 that are formed in the address pattern region Aa and the preamble pattern region Ap: the second concave/convex patterns) that construct parts of the servo patterns aside from the burst patterns and the area of the concaves 27 in the concave/convex patterns 25 (the concave/convex patterns 25 that are formed in the data recording regions At: the first concave/convex patterns) that construct the data track patterns to (ii) the total of the area of the convexes 26 in the concave/convex patterns 25 that construct parts of the servo patterns aside from the burst patterns and the area of the convexes 26 of the concave/convex patterns 25 that construct the data track patterns. By using this construction, since it is possible to significantly reduce the difference between the head flying height in a state where a burst pattern region is not located below the magnetic head 3 (slider) and the head flying height in a state where a burst pattern region that is located below the magnetic head 3 (slider), it is possible to significantly reduce the fluctuation in flying height of the magnetic head 3 per revolution of the magnetic disk (magnetic recording medium). By doing so, it is possible to reliably prevent the occurrence of head crashes.

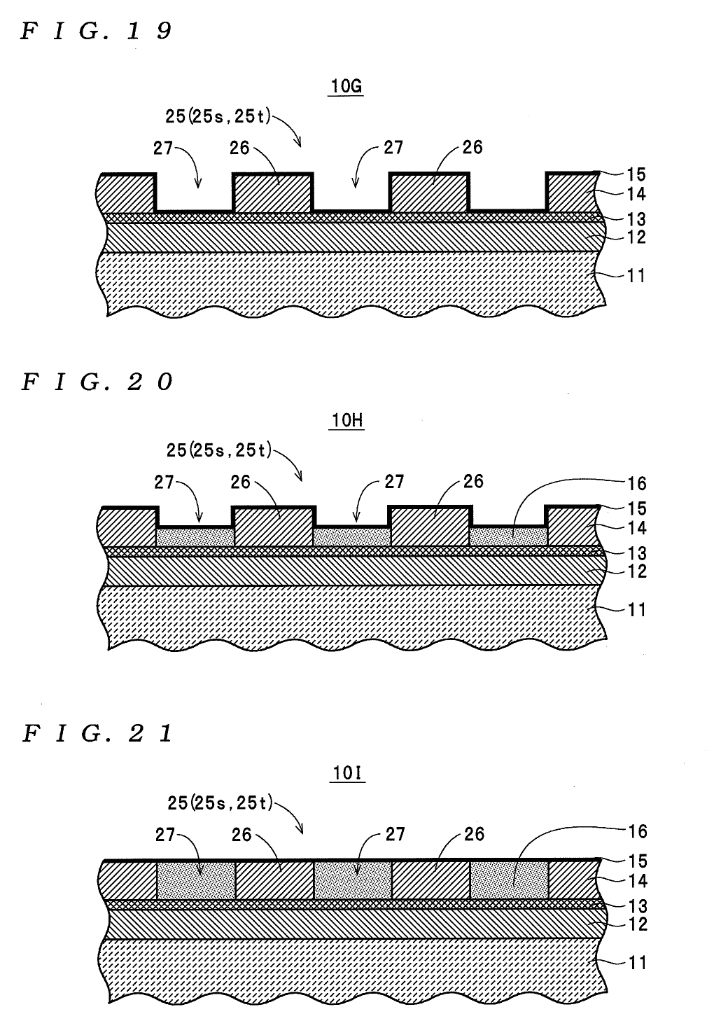

On the other hand, with the magnetic disks 10A to 10F described above, although the concave/convex patterns 25 have been formed so that the magnetic layer 14 is present at the bottom surfaces of the concaves 27 (so that the depth of the concaves 27 is less than the thickness of the magnetic layer 14), the constructions of the first concave/convex pattern and the second concave/convex pattern for the present invention are not limited to such. For example, like the magnetic disk 10G shown in FIG. 19, it is also possible to construct the concave/convex patterns 25 that correspond to the first concave/convex patterns and the second concave/convex patterns for the present invention by forming the concaves 27 with a depth that reaches the layer below the magnetic layer 14 (in this example, the intermediate layer 13). Also, like the magnetic disk 10H shown in FIG. 20 and the magnetic disk 10I shown in FIG. 21, it is possible to fill the concaves 27 formed in the magnetic layer 14 with a non-magnetic material 16.

Here, on the magnetic disks 10G, 10H described above, by forming the concave/convex patterns 25 by appropriately set the values of “M” and “L” for the present invention in the same way as with the magnetic disks 10A to 10F described earlier, it is possible to sufficiently reduce the fluctuation in the flying height of the magnetic head 3 per revolution. Also, on the magnetic disk 10I where the concaves 27 are filled with the non-magnetic material 16 up to the same height as the protruding end surfaces of the convexes 26 (a magnetic disk whose disk surface is smooth), the fluctuation in the flying height will be the same as the magnetic disk 10x3 described earlier regardless of how the values of “M” and “L” for the present invention are set. However, with the magnetic disk 10I also, by setting the values of “M” and “L” for the present invention in the same way as on the magnetic disks 10A to 10F described earlier, during manufacturing, it will be possible to press in the convexes 36 of the stamper uniformly across the entire range of the preform 20.

In addition, although examples (the magnetic disks 10A to 10F) have been described where the lengths along the direction of rotation of the first burst region Ab1 to the fourth burst region Ab4 are set equal at positions with the same radius, it is also possible to set such lengths at different values. Also, although an example (the magnetic disk 10D) has been described where the lengths along the direction of rotation of the burst regions Ab1a, Ab1b are the same at positions with the same radius, the lengths along the direction of rotation of the burst regions Ab2a, Ab2b are the same at positions with the same radius, the lengths along the direction of rotation of the burst regions Ab3a, Ab3b are the same at positions with the same radius, and the lengths along the direction of rotation of the burst regions Ab4a, Ab4b are the same at positions with the same radius, it is also possible to set such lengths at different values. When such lengths are set at different values, it is preferable to form the burst patterns by setting the number of burst regions where the burst signal unitary parts are constructed of concaves 27 (the value of “M” for the present invention) and the number of burst regions where the burst signal unitary parts are constructed of convexes 26 (the value of “L” for the present invention) in accordance with the various setting methods described above. By doing so, in the same way as the magnetic disk 10A and the like described earlier, it is possible to sufficiently reduce the fluctuation in the flying height of the magnetic head 3 per revolution.

In addition, on the magnetic disks 10A to 101 described above, although the data track patterns 25t and the data track patterns 25tf are formed in the data recording regions At by concave/convex patterns 25 with plural concentric or spiral convexes 26 (recording regions), the present invention is not limited to this and it is possible to adapt the present invention to a patterned medium where convexes that construct data recording tracks in data track patterns are separated from one another by having concaves in between in the direction of rotation (the circumferential direction) of the magnetic recording medium.

What is claimed is:

1. A magnetic recording medium on which data track patterns are formed by first concave/convex patterns in data recording regions on at least one surface of a substrate and servo patterns are formed by second concave/convex patterns in servo pattern regions located between the data recording regions on the at least one surface, the first and second concave/convex patterns including concaves and convexes where at least protruding end portions of the convexes are formed of a magnetic material,
wherein a burst pattern region of each servo pattern region includes N (where N is a natural number of at least two) burst regions, in which burst patterns, where plural burst signal unitary parts are aligned along a direction of rotation of the magnetic recording medium, are formed as the servo patterns,
the burst signal unitary parts formed in M (where M is a natural number no greater than (N−1)) out of the N burst regions are constructed of the concaves, and
the burst signal unitary parts formed in L (where L is a natural number equal to (N−M)) out of the N burst regions are constructed of the convexes.

2. The magnetic recording medium according to claim 1,
wherein values of M and L are set so that a ratio of an area of the concaves in the second concave/convex patterns that construct the burst patterns to an area of the convexes in the second concave/convex patterns that construct the burst patterns is as close as possible to a ratio of an area of the concaves in the first concave/convex patterns that construct the data track patterns to an area of the convexes in the first concave/convex patterns that construct the data track patterns.

3. The magnetic recording medium according to claim 1,
wherein values of M and L are set so that a ratio of an area of the concaves in the second concave/convex patterns that construct the servo patterns to an area of the convexes in the second concave/convex patterns that construct the servo patterns is as close as possible to a ratio of an area of the concaves in the first concave/convex patterns that construct the data track patterns to an area of the convexes in the first concave/convex patterns that construct the data track patterns.

4. The magnetic recording medium according to claim 1,
wherein values of M and L are set so that a ratio of an area of the concaves in the second concave/convex patterns that construct the burst patterns to an area of the convexes in the second concave/convex patterns that construct the burst patterns is as close as possible to a ratio of (i) a total of an area of the concaves in the second concave/convex patterns that construct parts of the servo patterns aside from the burst patterns and an area of the concaves in the first concave/convex patterns that construct the data track patterns to (ii) a total of an area of the convexes in the second concave/convex patterns that construct parts of the servo patterns aside from the burst patterns and an area of the convexes in the first concave/convex patterns that construct the data track patterns.

5. The magnetic recording medium according to claim 1,
wherein the burst patterns are formed in the burst pattern regions so that the burst regions in which the burst signal unitary parts are constructed of the concaves and the burst regions in which the burst signal unitary parts are constructed of the convexes alternate in the direction of rotation.

6. A recording/reproducing apparatus comprising the magnetic recording medium according to claim 1.

7. A stamper on which is formed a stamper-side concave/convex pattern including stamper-side convexes formed corresponding to one of the concaves and the convexes of the concave/convex patterns of the magnetic recording medium according to claim 1 and stamper-side concaves formed corresponding to another of the concaves and the convexes of the concave/convex patterns of the magnetic recording medium.
